(19) United States
(12) Patent Application Publication
(10) Pub. No.: US 2006/0205861 A1
(43) Pub. Date: Sep. 14, 2006

(54) Coating compositions comprising epoxy resins and aminofunctional silicone resins

(76) Inventors: Glenn Gordon, Midland, MI (US); John Bernard Horstman, Midland, MI (US); Donald Liles, Midland, MI (US); Randall Schmidt, Midland, MI (US); Gary Wieber, Midland, MI (US); Gerald Lawrence Witucki, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 10/564,612

(22) PCT Filed: Jul. 7, 2004
(86) PCT No.: PCT/US04/21665

§ 371 Date: Jan. 12, 2006

(30) Foreign Application Priority Data
Jul. 16, 2003 (US) 60487700

(51) Int. Cl. C08L 83/02

(52) U.S. Cl. 524/506

(57) ABSTRACT

This invention relates to a coating composition comprising (A) 100 weight parts of at least one epoxy resin; (B) 3-300 weight parts of at least one aminofunctional silicone resin; (C) up to 50 weight parts of at least one organic hardener; (D) up to 100 weight parts of at least one epoxyfunctional silicone resin; and (E) up to 10 weight parts of at least one cure accelerator. The coating compositions of this invention have acceptable moduli (>100 MPa), are tough, flexible, solvent and water resistant over a broad temperature range.

Siloxane resins are known in the art to have exceptional thermal stability and weatherability including low water absorption. However, their poor toughness, adhesion and dimensional stability (low Tg, high CTE) limit their utility. Epoxy resins exhibit very good toughness, solvent resistance, adhesion and dimensional stability but suffer from marginal thermal stability and high water absorption. This invention relates to coating compositions containing aminofunctional siloxane resins having a high D content (but low dimethyl siloxy content) and amine content and epoxy resins. The coating compositions are tough, high temperature resistant thermosets materials. Amino and epoxy functional silicone resins have been used to modify the properties of epoxy resins. For example, in U.S. Pat. No. 4,972,029 is disclosed thermally stable, crosslinked epoxy resins obtained by crosslinking an epoxy resin with a silicon compound containing a basic nitrogen which is bonded to silicon via carbon and to which at least 1 hydrogen atom is bonded directly to the nitrogen atom, and thereafter conditioning the crosslinked epoxy resin.

In U.S. Pat. No. 5,135,993 is disclosed a composition of matter comprising a blend of (A) a curable epoxy resin, or a mixture of curable epoxy resins, and (B) an amino functional silicone resin comprising the units (i) PhSiO_{3/2}, (ii) R₂SiO, and (iii) aminofunctional siloxy units selected from the group consisting essentially of: a) H₂NRⁱSiO_{3/2}, b) RᵢᵥHNRⁱⁱSiO_{3/2}, c) (R^{iv}HNRⁱⁱ)_{3-y}(R^{v})_{y}SiO_{1/2}, d) (H₂NRⁱⁱ)₃₋ₓ(R^{v})ₓSiO_{1/2} and, e mixtures of a, b, c, and d, wherein Ph is the phenyl radical; each R is independently selected from phenyl or alkyl groups of 1 to 3 carbon atoms with the proviso that when R in B(ii) is an alkyl radical in each case, there can be no more than 10 weight percent of B(ii) in the silicone resin and with the further proviso that when one R in B(ii) is an alkyl radical and one R in B(ii) is a phenyl radical on the same silicon atom, there can be no more than 15 weight percent of (ii) present in the silicone resin; Rⁱ is a divalent hydrocarbon radical selected from alkylene, arylene, alkarylene, or aralkylene having 1 to 10 carbon atoms, and —RⁱⁱNHRⁱⁱⁱ—, wherein Rⁱⁱ and Rⁱⁱⁱ are each independently selected from alkylene, arylene, alkarylene or aralkylene of 1 to 10 carbon atoms; each of x and y have a value of 0, 1, or 2; R^{iv} is selected from methyl, ethyl, propyl or phenyl; R^{v} is selected from methyl or phenyl, and the aminofunctional silicone resin has an —NH— equivalent in the range of 350 to 1000.

In U.S. Pat. No. 5,102,960 is disclosed a silicone-epoxy resin composition comprising (A) 100 parts by weight of a curable epoxy resin, (B) 1-100 parts by weight of an epoxy resin-modified silicone resin obtained by a condensation reaction of 1-99 mole % of an epoxy resin having at least one hydroxyl group and at least one epoxy group and 1-99 mole % of an organosiloxane or organosilane compound represented by the general formula

$$[ {R}_{n}^{1} Si {( {OR}^{2} )}_{m} {O}_{\frac{4 - ( m + n )}{2}} ] ,$$

wherein R¹ represents a monovalent hydrocarbon group or a halogenated monovalent hydrocarbon group, R² represents a hydrogen atom or a monovalent aliphatic hydrocarbon group, is a number ranging from 1 to 1,500; n is a number ranging from 0.9 to 3; and m is a number ranging from 0.05 to 3.1 with a proviso that the sum of m+n is not greater than 4, and (c) 1-100 parts by weight of an epoxy-modified polysiloxane having an epoxy equivalent ranging from 1,000 to 20,000, represented by the general formula 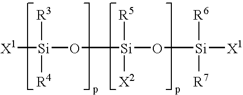
wherein R³, R⁴, R⁵, R⁶, and R⁷ may be the same or different, each represents a lower alkyl group or a substituted or unsubstituted phenyl group; X¹ represents a monovalent aliphatic hydrocarbon group or an epoxy-containing organic group; X² represents an epoxy-containing organic group p is an integer of 1 to 500; and q is an integer of 0 to 100.

In U.S. Pat. No. 5,561,174 is disclosed a liquid epoxy resin composition comprising (A) a liquid epoxy resin, (B) a dimethylpolysiloxane having epoxy groups at its both ends, and (C) a dispersing agent comprising the reaction product of (C-1) a dimethylpolysiloxane having amino groups or carboxyl groups reactive with epoxy resins at its side chains or both ends and having phenyl groups or polyether groups for improving its compatibility with epoxy resins at its side chains, and (C-2) an epoxy resin having the same structure as the component (A).

In U.S. Pat. No. 5,804,616 is disclosed epoxy-polysiloxane polymer compositions prepared by combining a resin component with a hardener component. The resin component comprises a non-aromatic epoxy resin ingredient and a polysiloxane ingredient. The hardener component comprises an amine and optionally an organotin catalyst. The composition can also include aggregates, pigments, and other additives depending on the particular end use. The composition is prepared using a sufficient amount of water to promote hydrolysis of the polysiloxane and the polycondensation of the silanols produced by such hydrolysis. In its cured form, the epoxy-polysiloxane composition exists as a uniformly dispersed arrangement of linear epoxy chain fragments that are cross-linked with a continuous polysiloxane polymer chain, thereby forming a non-interpenetrating polymer network chemical structure that has substantial advantages over conventional epoxy systems.

In U.S. Pat. No. 6,071,990 is disclosed a composition for use in silicone coatings comprising an epoxy resin, an amine functional silane, an organometallic compound and an organic solvent. The composition is disclosed as being used in combination with OH-terminated diorganosiloxane coatings to form resilient films having good freeze-release properties and improved abrasion resistance over previously known coatings.

When silicone resins are added to epoxy compounds at high loadings the glass transition temperature of the coating composition is within the use range and it is accompanied by a large drop in modulus which hinders the reliability of devices based on these materials. When linear silicones are formulated with epoxy compounds the coating loses its solvent resistance. Amino functional resins with high phenyl content, high amine content and greater than 20 weight perscent diorganosiloxy units, used at high loadings with epoxy compounds provide coating compositions having acceptable moduli (>100 MPa), tough, flexible, solvent and water resistant materials with low CTE (<100 ppm/° C.) over a broad temperature range.

Thus this invention relates to a coating composition comprising (A) 100 weight parts of at least one epoxy resin; (B) 3-300 weight parts of at least one aminofunctional silicone resin comprising the units:

(R₃SiO_{1/2})ₐ (i)

(R₂SiO_{2/2})_{b} (ii)

(RSiO_{3/2})_{c} (iii) and

(SiO_{4/2})_{d} (iv)

wherein R is independently an alkyl group, an aryl group, or an aminofunctional hydrocarbon group, a has a value of less than 0.4, b has a value of greater than 0.15, c has a value of greater than zero to 0.7, d has a value of less than 0.2, the value of a+b+c+d=1, with the provisos that 3 to 50 mole percent of silicon atoms contain aminofunctional hydrocarbon groups in units (i), (ii) or (iii), the —NH— equivalent weight of the aminofunctional silicone resin is from 100 to 1500, alternatively from 100 to 1000, alternatively from 150 to 350, the aminofunctional silicone resin is in the form of a neat liquid, solution, or meltable solid, greater than 20 weight percent of unit (ii) is present in the aminofunctional silicone resin, less than 10 weight percent of unit (ii) are Me₂SiO_{2/2} units in the aminofunctional silicone resin, and greater than 50 weight percent of silicon-bonded R groups are silicon-bonded aryl groups; (C) up to 50 weight parts of at least one organic hardener; (D) up to 100 weight parts of at least one epoxyfunctional silicone resin comprising the units:

((R³)₃SiO_{1/2})ₑ (i)

((R³)₂SiO₂/2)_{f} (ii) and

((R³)SiO_{3/2})_{g} (iii)

wherein R³ is independently an alkyl group having from 1 to 8 carbon atoms, an aryl group having from 1 to 8 carbon atoms, a glycidyl ether group, an alkyl epoxy group, or a cycloaliphatic epoxy group, e has a value of 0.1 to 0.5, f has a value of 0.1 to 0.5, and g has a value of 0.5 to 0.9, with the proviso that the epoxyfunctional silicone resin has an epoxy equivalent weight of 200 to 700; and (1) up to 10 weight parts of at least one cure accelerator.

The —NH— equivalent weight as used herein means the weight of material that contains one atomic weight of amine hydrogen.

Component (A), the epoxy resin, can be any epoxy resin having at least two epoxy groups in one molecule, that can be cured by combination with a curing agent. As to its molecular structure and molecular weight, there is no particular restriction. Component (A) is illustrated by diglycidyl ether resin, novolak epoxy resin, o-cresol novolak epoxy resins, phenol novolak epoxy resins, cycloaliphatic epoxy resins, glycidyl ethers of polyvalent phenols such as diglycidyl ether of bisphenol A (DGEBPA) and diglycidyl ether of bisphenol F (DGEBPF), the glycidyl ethers of other bisphenols and glycidyl ethers of mononuclear diphenols such as glycidyl ethers of resorcinol, glycidyl ethers of hydroquinone, and glycidyl ethers of catechol, polygycidyl ethers of phenol novolak epoxy resins such as phenol formaldehyde novolak, alicyclic epoxy resins derived from the epoxidation of an olefin bond, the product of the reaction of 2,2-bis-(hydroxy-phenyl)-propane (bisphenol A) and epichlorohydrin, triglycidyl isocyanurate, and products obtained from the reaction of bis-(4-hydroxy-phenyl)-methane (bisphenol F) and epichlorohydrin.

Component (A) is more specifically illustrated by resorcinol diglycidyl ether {1,3-bis-(2,3-epoxypropoxy)benzene} marketed, for example, by Wilmington Chemical as HELOXY®D69; DER® 331 a diglycidyl ether of bisphenol A epoxy resin sold by The Dow Chemical Company (Midland Mich.); ERL® 4221D a cycloaliphatic epoxy resin sold by The Dow Chemical Company (Midland, Mich.; triglycidyl p-aminophenol {4-(2,3-epoxypropoxy)-N,N-bis{2,3-epoxypropyl)aniline}; diglycidyl ether of bromobisphenol A {2,2-bis(4-{2,3-epoxypropoxy)3-bromo-phenyl)propane; diglydicylether of Bisphenol F (2,2-bis(p-(2,3-epoxypropoxy)phenyl)methane); triglycidyl ether of meta and/or para-aminophenol (3-(2,3-epoxypro glycidyl ethers of epoxy)N,N-bis(2,3-epoxypropyl)aniline); and tetraglycidyl methylene dianiline (N,N,N′,N′-tetra(2,3-epoxypropyl) 4,4′-diaminodiphenyl methane) or mixtures of two or more mixtures of two or more epoxy resins can be used in this invention. A more exhaustive list of the epoxy resins found useful in this invention can be found in Lee, H. and Neville, K., Handbook of Epoxy Resins, McGraw-Hill Book Company, 1982 reissue.

In Component (B), the aminofunctional silicone resin, the alkyl groups of R are illustrated by methyl, ethyl, propyl, butyl, hexyl, octyl, decyl, dodecyl, hexadecyl, and octadecyl with the alkyl group typically being methyl. The aryl groups are illustrated by phenyl, naphthyl, benzyl, tolyl, xylyl, xenyl, methylphenyl, 2-phenylethyl, 2-phenyl-2-methylethyl, chlorophenyl, bromophenyl and fluorophenyl with the aryl group typically being phenyl. The aminofunctional hydrocarbon group is illustrated by groups having the formula —R¹NHR² or —R¹NHR¹NHR² wherein each R¹ is independently a divalent hydrocarbon radical having at least 2 carbon atoms and R² is hydrogen or an alkyl group. Each R¹ is typically an alkylene radical having from 2 to 20 carbon atoms. R¹ is illustrated by —CH₂CH₂—, —CH₂CH₂CH₂—, —CH₂CHCH₃—, —CH₂CH₂CH₂CH₂—CH₂CH(CH₃)CH₂—, —CH₂CH₂CH₂CH₂CH₂—, —CH₂CH₂CH₂CH₂CH₂CH₂—, —CH₂CH₂CH(CH₂CH₃)CH₂CH₂CH₂—, —CH₂CH₂CH₂CH₂CH₂CH₂CH₂CH₂—, and —CH₂CH₂CH₂CH₂CH₂CH₂CH₂CH₂CH₂CH₂—. The alkyl groups R² are as illustrated above for R. When R² is an alkyl group it is typically methyl.

Typical aminofunctional hydrocarbon groups are —CH₂CH₂NH₂, —CH₂CH₂CH₂NH₂, —CH₂CHCH₃NH, —CH₂CH₂CH₂CH₂NH₂, —CH₂CH₂CH₂CH₂CH₂NH₂, —CH₂CH₂CH₂CH₂CH₂CH₂NH₂, —CH₂CH₂NHCH₃, —CH₂CH₂CH₂NHCH₃, —CH₂(CH₃)CHCH₂NHCH₃, —CH₂CH₂CH₂CH₂NHCH₃, —CH₂CH₂NHCH₂CH₂NH₂, —CH₂CH₂CH₂NHCH₂CH₂CH₂NH₂, —CH₂CH₂CH₂CH₂NHCH₂CH₂CH₂CH₂NH₂, —CH₂CH₂NHCH₂CH₂NHCH₃, —CH₂CH₂CH₂NHCH₂CH₂CH₂NHCH₃, —CH₂CH₂CH₂CH₂NHCH₂CH₂CH₂CH₂NHCH₃, and —CH₂CH₂NHCH₂CH₂NHCH₂CH₂CH₂CH₃.

The aminofunctional silicone resins of this invention are illustrated by aminofunctional silicone resins comprising the units:

(i) ((CH₃)₃SiO_{1/2})ₐ

(ii) (C₆H₅(CH₃)SiO_{2/2})_{b}

(iii) ((CH₃)RSiO_{2/2})_{b} where R═—CH₂CH₂CH₂NH₂

(iv) (C₆H₅SiO_{3/2})_{c},

aminofunctional silicone resins comprising the units:

(i) (C₆H₅(CH₃)SiO_{2/2})_{b}

(ii) ((CH₃)RSiO_{2/2})_{b} where R═—CH₂CH₂CH₂NH₂

(iii) (C₆H₅SiO_{3/2})_{c},

aminofunctional silicone resins comprising the units:

(i) ((CH₃)₃SiO_{1/2})ₐ

(ii) ((CH₃)RSiO_{2/2})_{b} where R═—CH₂CH₂CH₂NH₂

(iii) (RSiO_{3/2})_{c} where R═—CH₂CH₂CH₂NH₂

(iv) (C₆H₅SiO_{3/2})_{c},

aminofunctional silicone resins comprising the units:

(i) ((CH₃)₃SiO_{1/2})ₐ

(ii) ((CH₃)RSiO_{2/2})_{b} where R═—CH₂CH₂CH₂NH₂

(iii) (C₆H₅SiO_{3/2})_{c}

aminofunctional silicone resin comprising the units

(i) ((CH₃)₃SiO_{1/2})ₐ

(ii) (CH₃)₂SiO_{2/2})_{b}

(iii) ((CH₃)RSiO_{2/2})_{b} where R═—CH₂CH₂CH₂NH₂

(iv) (C₆H₅SiO_{3/2})_{c}

aminofunctional silicone resin comprising the units:

(i) ((CH₃)₂RSiO_{1/2})ₐ where R═—CH₂(CH₃)CHCH₂NHCH₃

(ii) (CH₃)₂SiO_{2/2})_{b}

(iii) (C₆H₅(CH₃)SiO_{2/2})_{b}

(iv) (C₆H₅SiO_{3/2})_{c}

aminofunctional silicone resins comprising the units:

(i) ((CH₃)₂RSiO_{1/2})ₐ where R═—CH₂(CH₃)CHCH₂NHCH₃

(ii) (C₆H₅(CH₃)SiO_{2/2})_{b}

(iii) (C₆H₅SiO_{3/2})_{c},

aminofunctional silicone resins comprising the units:

(i) ((CH₃)RSiO_{2/2})_{b} where R═—CH₂(CH₃)CHCH₂NHCH₃

(ii) (C₆H₅(CH₃)SiO_{2/2})_{b}

(iii) (C₆H₅SiO_{3/2})_{c},

aminofunctional silicone resins comprising the units:

(i) ((CH₃)₂RSiO_{1/2})ₐ where R═—CH₂(CH₃)CHCH₂NHCH₃

(ii) (C₆H₅(CH₃)SiO_{2/2})_{b}

(iii) (SiO_{4/2})_{d}, and

aminofunctional silicone resins comprising the units:

(i) ((CH₃)₃SiO_{1/2})ₐ

(ii) (C₆H₅(CH₃)SiO_{2/2})_{b}

(iii) ((CH₃)RSiO_{2/2})_{b} where R═—CH₂CH₂CH₂NH₂

(iv) (C₆H₅SiO_{3/2})_{c}

(v) (SiO_{4/2})_{d}

wherein a, b, c, and d are as defined above.

In the aminofunctional silicone resin a has a typical value of 0.1 to 0.3, b has a typical value of 0.2 to 0.4, c has a typical value of 0.2 to 0.5, d has a typical value of 0. Generally,

10 to 30 mole percent of silicon atoms contain aminofunctional hydrocarbon groups in units (i), (ii) or (iii), the —NH— equivalent weight of the aminofunctional silicone resin is generally from 150 to 1000, alternatively from 150 to 350, generally 20 to 50 weight percent of unit (ii) is present in the aminofunctional silicone resin, generally from 0 to 5 weight percent of unit (ii) are Me₂SiO_{2/2} units in the aminofunctional silicone resin, and generally from 50 to 75 weight percent of silicon-bonded R groups are silicon-bonded aryl groups.

Generally, the aminofunctional silicone resins of this invention were prepared by reaction of a cyclic silazane with a hydroxy-containing siloxane resin or by hydrolytic polycondensation of alkoxysilanes by one of two methods. In some cases, the hydrolysis of the non-aminofunctional alkoxysilanes was accomplished via catalysis with strong acid, followed by addition of the aminofunctional silanes and base-catalyzed equilibration of these species to yield the aminofunctional silicone resin. In other cases, the entire hydrolysis was run under base-catalyzed conditions with the aminofunctional alkoxysilane(s) present from the start. In both cases, the hydrolysis was followed by distillative removal of by-product alcohol, filtration and removal of solvent to provide the product.

More specifically the aminofunctional silicone resins of this invention can be manufactured by preparing a mixture of 45-60 wt % of aryltrialkoxysilane, arylalkyldialkoxysilane, γ-amioalkyltrialkoxysilane, γ-aminoalkyldialkoxysilane and/or γ-aminoalkylmonoalkoxysilane optionally dissolving the mixture in up to 35 wt % of an aromatic solvent. This mixture is then hydrolyzed with 1-20 wt % of deionized water, followed by distillative removal of the by-product alcohol. The resulting product is then optionally reacted with up to 50 wt % of trialkylalkoxysilane, hexamethyldisilazane (HMDZ), γ-aminoalkyldialkoxysilane, γ-aminoalkylmonoalkoxysilane and/or dialkyldialkoxysilane, up to 35 wt % of additional solvent, and up to 20 wt % water can be added, a catalytic amount (to make 0-0.1 wt % KOH) of aqueous potassium hydroxide can then be optionally added and the water removed via azeotrope. The hydroxide, if added, is neutralized with aqueous HCl or acetic acid, and water removed again via azeotrope. The mixture is then filtered and solvent removed to yield the aminofunctional silicone resin. Typically the aryl group is phenyl, the alkyl group is methyl, the alkoxy group is either methoxy or ethoxy, and the amino group is the aminofunctional hydrocarbon group described above.

The aminofunctional silicone resins of this invention can also be manufactured by hydrolyzing 20-50 wt % of aryltrialkoxysilane and/or arylalkyldialkoxysilane, catalyzed by 0-0.05 wt % with trirluoromethanesulfonic acid (TFMSA), with deionized water (0-10 wt %), followed by distillative removal of by-product alcohol. Up to 35 wt % of hexamethyldisiloxane (HMDS), up to 10 wt % water, and optionally up to 40 wt % toluene is added and the mixture heated to 50-60° C. optionally followed by distillative removal of volatiles. Up to 20 wt % of γ-aminoalkyltrialkoxysilane (APTES), γ-aminoalkylmonoalkoxysilane or γ-aminoalkyldialkoxyalkylsilane are added along with up to 10 wt % water, followed by distillative removal of alcohol. Up to 40 wt % of toluene (if it was not added earlier) is added, up to 10 wt % of water, and optionally a catalytic amount (to make 0-0.1 wt % KOH) of 1.0 N aqueous potassium hydroxide is added and water removed via azeotrope. If added, the hydroxide was neutralized with 1.0 N aqueous HCl or acetic acid, and water again removed via azeotrope. The mixture was filtered and solvent removed to yield the aminofunctional silicone resin. Typically the aryl group is phenyl, the alkyl group is methyl, the alkoxy group is either methoxy or ethoxy, and the amino group is the aminofunctional hydrocarbon group described above.

The aminofunctional silicone resins of this invention can also be manufactured by preparing a mixture of aryltrialkoxysilane, arylalkyldialkoxysilane, and γ-aminoalkyldialkoxyalkylsilane optionally dissolved in xylenes and hydrolyzed with deionized water, followed by distillative removal of by-product alcohol. The resulting product is then reacted with trialkylalkoxysilane, additional xylenes and additional water, followed by azeotropic removal of water. To a portion of this reaction mixture, additional xylene and colloidal silica dispersion are added and the water removed via azeotrope. The mixture is filtered and solvent removed to yield the silicone resin. Typically the aryl group is phenyl, the alkyl group is methyl, the alkoxy group is either methoxy or ethoxy, and the amino group is the aminofunctional hydrocarbon group described above.

The aminofunctional silicone resins of this invention can also be manufactured by preparing a mixture of aryltrialkoxysilane and arylalkyldialkoxysilane optionally dissolved in xylenes and hydrolyzed with deionized water, followed by distillative removal of by-product alcohol. The resulting product is then reacted with cyclosilazane. The mixture is filtered and solvent removed to yield the silicone resin. Typically the aryl group is phenyl, the alkyl group is methyl, the alkoxy group is either methoxy or ethoxy, and the amino group is the aminofunctional hydrocarbon group described above.

Component (C) the organic hardener, is typically any multifunctional primary or secondary polyamines and their adducts, anhydrides, or polyamides. The organic hardener can be any compound with an active group capable of reacting with the epoxy group. It can be selected from compounds with amino, acid, anhydride or azide group. The organic hardener is illustrated by an aromatic diamine such as a diaminodiphenyl-sulfone, a methylenedianiline such as 4,4′-methylenedianiline, a diaminodiphenylether, benzidine, 4,4′-thiodianiline, 4-methoxy-6-m-phenylenediamine, 2,6-diaminopyridine, 2,4-toluenediamine, and dianisidine. Alicyclic amines such as menthane diamine and heterocyclic amines such as pyridine may also be employed. In some cases, aliphatic amines such as secondary alkylamines which are normally fast reacting hardeners can be used alone or in combination with other organic hardeners provided the concentration and/or curing temperature are sufficiently low to permit control of the curing rate. Some preferred commercial organic hardeners are illustrated by Versamine® C-30 a cycloaliphatic amine curing agent sold by Cognis (Cincinnati, Ohio) and Dytek® EP an aliphatic amine curing agent sold by DuPont, (Wilmington, Del.).

In Component (D), the alkyl group of R³ is illustrated by methyl, ethyl, propyl, butyl, hexyl, and octyl, with the alkyl group typically being methyl. The aryl group of R³ is illustrated by phenyl, naphthyl, benzyl, tolyl, xylyl, xenyl, methylphenyl, 2-phenylethyl, 2-phenyl-2-methylethyl, chlorophenyl, bromophenyl and fluorophenyl with the aryl group typically being phenyl. The glycidyl ether group is illustrated by alkyl glycidyl ether groups such as 2-glycidoxyethyl, 3-glycidoxypropyl, 4-glycidoxybutyl, 2-(3,4-epoxycyclohexyl)ethyl. Examples of the alkyl epoxy groups are 2,3-epoxypropyl, 3,4-epoxybutyl, and 4,5-epoxypentyl, and the cycloaliphatic epoxy group is illustrated by monovalent epoxycycloalkyl groups such as 3,4-epoxycyclohexylmethyl, 3,4-epoxycyclohexylethyl, 3,4-epoxycyclohexylpropyl, 3,4-epoxycyclohexylbutyl, and alkyl cyclohexene oxide groups.

The epoxyfunctional silicone resins of this invention are illustrated by epoxyfunctional silicone resins comprising the units:

(R³(CH₃)₂SiO_{1/2})ₑ

(C₆H₅SiO_{3/2})_{g},

epoxyfunctional silicone resins comprising the units:

(R³(CH₃)₂SiO_{1/2})ₑ

((CH₃₂SiO_{2/2})_{f}

(C₆H₅SiO_{3/2})_{g},

epoxyfunctional silicone resins comprising the units:

((CH₃)₃SiO_{1/2})ₑ

(R³(CH₃)SiO_{2/2})_{f}

(C₆H₅SiO_{3/2})_{g},

epoxyfunctional silicone resins comprising the units:

(R³(CH₃)SiO_{2/2})_{f}

(C₆H₅SiO_{3/2})_{g},

epoxyfunctional silicone resins comprising the units:

(R³(CH₃)₂SiO_{1/2})ₑ

(CH₃SiO_{3/2})_{g},

epoxyfunctional silicone resins comprising the units:

(R³(CH₃)₂SiO_{1/2})ₑ

((CH₃)₂SiO_{2/2})_{f}

(CH₃SiO_{3/2})_{g},

epoxyfunctional silicone resins comprising the units:

((CH₃)₃SiO_{1/2})ₑ

(R³(CH₃)SiO₂₂)_{f}

(CH₃SiO_{3/2})_{g},

epoxyfunctional silicone resins comprising the units:

(R³(CH₃)SiO_{2/2})_{f}

(CH₃SiO_{3/2})_{g}

epoxyfunctional silicone resins comprising the units:

((CH₃)₂SiO_{2/2})_{f}

(R³SiO_{3/2})_{g},

wherein R³ is a glycidyl ether group, an alkyl epoxy group, or a cycloaliphatic epoxy group as illustrated above, e has a value of 0.1 to 0.5, f has a value of 0.1 to 0.5, and g has a value of 0.5 to 0.9, with the proviso that the epoxyfunctional silicone resin has an epoxy equivalent weight of 200 to 700.

Component (E), the cure accelerator, is a compound that accelerates the reaction between epoxy groups in the epoxy resin and active groups in the hardener. Examples of the cure accelerator include phosphine compounds, such as tributylphosphine, triphenylphosphine, tris(dimethoxyphenyl)phosphine, tris(hydroxypropyl)phosphine and tris(cyanoethyl)phosphine; phosphonium salts, such as tetraphenylphosphonium tetraphenylborate, methyltributylphosphonium tetraphenylborate and methyltricyanoethyl phosphonium tetraphenylborate; imidazoles, such as 2-methyl imidazole, 2-phenyl imidazole, 2-ethyl-4-methyl imidazole, 2-undecyl imidazole, 1-cyanoethyl-2-methyl imidazole, 1,4-dicyano-6-[2-methylimidazolyl-(1)]-ethyl-S-triazine and 2,4-dicyano-6-[2-undecylimidazolyl-(1)]-ethyl-S-triazine; imidazolium salts, such as 1-cyanoethyl-2-undecylimidazolium trimellitate, 2-methylimidazolium isocyanurate, 2-ethyl-4-methylimidazolium tetraphenylborate and 2-ethyl-1,4-dimethylimidazolium tetraphenylborate; amines, such as 2,4,6-tris(dimethylaminomethyl)phenol, benzyl dimethylamine, tetramethylbutyl guanidine, N-methyl piperazine and 2-dimethylamino-1-pyrroline; ammonium salts, such as triethylammonium tetraphenylborate; diazabicyclo compounds, such as 1,5-diazabicyclo(5,4,0)-7-undecene, 1,5-diazabicyclo(4,3,0)-5-nonene and 1,4-diazabicyclo(2,2,2)-octane; and tetraphenylborates, phenol salts, phenol novolak salts and 2-ethylhexanoates of those diazabicyclo compounds, and alcohols such as resorcinol. Dicyandiamide and boron trifluoride can also be used as cure accelerators.

In the coating compositions of this invention the —NH— (amine H) equivalent weight to epoxy ring equivalent weight ratio is typically from 0.8:1-1.2:1.

The coating compositions of this invention can further comprise (F) at least one surfactant. The surfactant may be an anionic, cationic, nonionic, or amphoteric surfactant. The surfactants may be employed separately or in combinations of two or more. Examples of suitable anionic surfactants include alkali metal sulforicinates, sulfonated glyceryl esters of fatty acids such as sulfonated monoglycerides of coconut oil acids, salts of sulfonated monovalent alcohol esters such as sodium oleylisethianate, amides of amino sulfonic acids such as the sodium salt of oleyl methyl tauride, sulfonated products of fatty acids nitriles such as palmitonitrile sulfonate, sulfonated aromatic hydrocarbons such as sodium alpha-naphthalene monosulfonate, condensation products of naphthalene sulfonic acids with formaldehyde, sodium octahydroanthracene sulfonate, alkali metal alkyl sulfates such as sodium lauryl sulfate, ammonium lauryl sulfate or triethanol amine lauryl sulfate, ether sulfates having alkyl groups of 8 or more carbon atoms such as sodium lauryl ether sulfate, ammonium lauryl ether sulfate, sodium alkyl aryl ether sulfates, and ammonium alkyl aryl ether sulfates, alkylarylsulfonates having 1 or more alkyl groups of 8 or more carbon atoms, alkylbenzenesulfonic acid alkali metal salts exemplified by hexylbenzenesulfonic acid sodium salt, octylbenzenesulfonic acid sodium salt, decylbenzenesulfonic acid sodium salt, dodecylbenzenesulfonic acid sodium salt, cetylbenzenesulfonic acid sodium salt, and myristylbenzenesulfonic acid sodium salt, sulfinic esters of polyoxyethylene alkyl ether including CH₃(CH₂)₆CH₂O(C₂H₄O)₂SO₃H, CH₃(CH₂)₇CH₂O(C₂H₄O)_{3.5}SO₃H, CH₃(CH₂)₈CH₂O(C₂H₄O)₈SO₃H, CH₃(CH₂)₁₉CH₂O(C₂H₄O)₄SO₃H, and CH₃(CH₂)₁₀CH₂O(C₂H₄O)₆SO₃H, sodium salts, potassium salts, and amine salts of alkylnaphthylsulfonic acid.

Examples of cationic surfactants include various fatty acid amines and amides and their derivatives, and the salts of the fatty acid amines and amides. Examples of aliphatic fatty acid amines include dodecylamine acetate, octadecylamine acetate, and acetates of the amines of tallow fatty acids, homologues of aromatic amines having fatty acids such as dodecylanalin, fatty amides derived from aliphatic diamines such as undecylimidazoline, fatty amides derived from aliphatic diamines such as undecylimidazoline, fatty amides derived from disubstituted amines such as oleylaminodiethylamine, derivatives of ethylene diamine, quaternary ammonium compounds and their salts which are exemplified by tallow trimethyl ammonium chloride, dioctadecyldimethyl ammonium chloride, didodecyldimethyl ammonium chloride, dihexadecyl ammonium chloride, alkyltrimethylammonium hydroxides such as octyltrimethylammonium hydroxide, dodecyltrimethylammonium hydroxide, or hexadecyltrimethylammonium hydroxide, dialkyldimethylammonium hydroxides such as octyldimethylammonium hydroxide, decyldimethylammonium hydroxide, didodecyldimethylammonium hydroxide, dioctadecyldimethylammonium hydroxide, tallow trimethylammonium hydroxide, coconut oil, trimethylammonium hydroxide, methylpolyoxyethylene cocoammonium chloride, and dipalmityl hydroxyethylammonium methosulfate, amide derivatives of amino alcohols such as beta-hydroxylethylstearylamide, and amine salts of long chain fatty acids.

Examples of nonionic surfactants include polyoxyethylene alkyl ethers, polyoxyethylene alkylphenol ethers, polyoxyethylene lauryl ethers, polyoxyethylene sorbitan monoleates, polyoxyethylene alkyl esters, polyoxyethylene sorbitan alkyl esters, polyethylene glycol, polypropylene glycol, diethylene glycol, ethoxylated trimethylnonanols, and polyoxyalkylene glycol modified polysiloxane surfactants.

Examples of the amphoteric surfactants that can be used include amino acid surfactants and betaine acid surfactants.

Typical commercially available surfactants include trimethylnonyl polyethylene glycol ethers and polyethylene glycol ether alcohols containing linear alkyl groups having from 11 to 15 such as 2,6,8-trimethyl-4-nonyloxypolyethylene oxyethanol (6 EO) (sold as Tergitol®TMN-6 by The Dow Chemical Company, Midland, Mich.), 2,6,8-trimethyl-4 nonyloxypolyethylene oxyethanol (10 EO) (sold as Tergitol®TMN-10 by The Dow Chemical Company, Midland, Mich.), alkylene-oxypolyethylene oxyethanol (C₁₁₋₁₅ secondary alkyl, 9 EO) (sold as Tergitol®15-S-9 by The Dow Chemical Company, Midland, Mich.), alkylene-oxypolyethylene oxyethanol (C₁₁₋₁₅ secondary alkyl, 15 EO) (sold as Tergitol®15-S-15 by The Dow Chemical Company, Midland, Mich.), octylphenoxy polyethoxy ethanols having varying amounts of ethylene oxide units such as octylphenoxy polyethoxy ethanol (40 EO) (sold as Triton® X405 by Rohm and Haas Company, Philadelphia, Pa.), nonionic ethoxylated tridecyl ethers available from Emery Industries, Mauldin, S.C. under the general tradename Trycol, alkali metal salts of dialkyl sulfosuccinates available from American Cyanamid Company, Wayne, N.J. under the general tradename Aerosol, polyethoxylated quaternary ammonium salts and ethylene oxide condensation products of the primary fatty amines, available from Armak Company, Chicago, Ill. under the tradenames Ethoquad, Ethomeen, or Arquad, and polyoxyalkylene glycol modified polysiloxanes. These preferred surfactants may also be obtained from other suppliers under different tradenames.

Surfactants useful in the invention also include those derived from silicone, sorbitan derivatives, and fatty alcohol derivatives. More specifically, suitable surfactants include, but are not limited to, sorbitan sesquioleate, sorbitan oleate, sorbitan isostearate; alkoxylated alcohols such as ethoxylated fatty alcohols including laureth-4, laureth-7, deceth-12, steareth-10; hydroxylated derivatives of polymeric silicones, such as dimethicone copolyol; alkylated derivatives of hydroxylated polymeric silicones such as cetyl dimethicone copolyol; glyceryl esters such as polyglyceryl-4-isostearate; and mixtures thereof, especially mixtures of hydroxylated derivatives of polymeric silicones, alkylated derivatives of hydroxylated polymeric silicones and glyceryl esters, most especially mixtures of dimethicone copolyol, cetyl dimethicone copolyol and polyglyceryl-4-isostearate. Most preferred is a mixture of such surfactants, i.e. a dimethicone copolyol, sorbitan sesquioleate and laureth-7.

The amount of Component (F) in the coating composition is typically from about 1 to 20 weight parts per 100 weight parts of coating composition.

The compositions of this invention can further comprise (G) is water. Generally water is present at a level of from about 20 to 80 weight parts per 100 weight parts of coating composition.

The compositions of this invention can further comprise fragrances, preservatives, vitamins, ceramides, amino-acid derivatives, liposomes, polyols, such as glycerine and propylene glycol and botanicals (plant extracts) and additional conditioning agents such as quaternary polymers or silicone materials. Other additives can include, but should not be limited to the following depending on the use, glycols, vitamins A, vitamin C and vitamin E in their various forms, Pro-Vitamin B5, sunscreen agents (these include those which absorb ultraviolet light between about 290-320 nanometers (the UV-B region) and those which absorb ultraviolet light in the range of 320-400 (the UV-B region)), humectants, preservatives, such as known parabens, emollients, occlusive agents, and esters. Other additives can include pigments especially when the emulsion is used as a make-up.

The compositions according to the invention can also contain agents for artificially tanning and/or browning the skin (self-tanning agents), such as, for example, dihydroxyacetone (DHA). These optional ingredients can be present in the coating compositions of this invention up in an amount of up to 5 parts by weight per 100 parts by weight of the coating composition, but typically are present in amount of from 0.1 to 1 part by weight per 100 parts by weight of the coating composition. Also the coating composition can be in the form of an emulsion when surfactants and water are present and this emulsion can be spray dried to form a resin/active composite particle.

The coating compositions of this invention may be prepared by mixing (or mechanically agitating) components (A) and (B), and any optional components, to form a homogenous mixture. This may be accomplished by any convenient mixing method known in the art exemplified by a spatula, mechanical stirrers, in-line mixing systems containing baffles and/or blades, powered in-line mixers, homogenizers, a drum roller, a three-roll mill, a sigma blade mixer, a bread dough mixer, and a two roll mill. The order of mixing is not considered critical.

The coating compositions of this invention are useful as a stand alone coating or as ingredients in flame retardant coating compositions, UV resistant coating compositions, paint formulations, powder coatings, architectural coatings and adhesives. The coating compositions of this invention have enhanced flexibility and gloss, particularly when used in coatings, paints, powder coatings, architectural coatings, and adhesives.

This invention also relates to a coating composition obtained by a method comprising

reacting (A) 100 weight parts of at least one epoxy resin; (B) 3-300 weight parts of at least one aminofunctional silicone resin comprising the units:

(R₃SiO_{1/2})ₐ (i)

(R₂SiO_{2/2})_{b} (ii)

(RSiO_{3/2})_{c} (iii) and

(SiO_{4/2})_{d} (iv)

wherein R is independently an alkyl group, an aryl group, or an aminofunctional hydrocarbon group, a has a value of less than 0.4, b has a value of greater than 0.15, c has a value of greater than zero to 0.7, d has a value of less than 0.2, the value of a+b+c+d=1, with the provisos that 3 to 50 mole percent of silicon atoms contain aminofunctional hydrocarbon groups in units (i), (ii) or (iii), the —NH— equivalent weight of the aminofunctional silicone resin is from 100 to 1500, alternatively from 100 to 1000, alternatively from 150 to 350, the aminofunctional silicone resin is in the form of a neat liquid, solution, or meltable solid, greater than 20 weight percent of unit (ii) is present in the aminofunctional silicone resin, less than 10 weight percent of unit (ii) are Me₂SiO_{2/2} units in the aminofunctional silicone resin, and greater than 50 weight percent of silicon-bonded R groups are silicon-bonded aryl groups; (C) up to 50 weight parts of at least one organic hardener; (D) up to 100 weight parts of at least one epoxyfunctional silicone resin comprising the units:

((R³)₃SiO_{1/2})ₑ (i)

((R³)₂SiO_{2/2})_{f} (ii) and

((R³)SiO_{3/2})_{g} (iii)

wherein R³ is independently an alkyl group having from 1 to 8 carbon atoms, an aryl group having from 1 to 8 carbon atoms, a glycidyl ether group, an alkyl epoxy group, or a cycloaliphatic epoxy group, e has a value of 0.1 to 0.5, f has a value of 0.1 to 0.5, and g has a value of 0.5 to 0.9, with the proviso that the epoxyfunctional silicone resin has an epoxy equivalent weight of 200 to 700; and (E) up to 10 weight parts of at least one cure accelerator. “Reacting” as used herein means mixing components (A) and (B) and any optional components at room temperature (20-25° C.) or heating a mixture comprising components (A) and (B) and any optional components to temperatures above room temperature such as at temperatures of up to 200° C. Components (A)-(E) are as described above.

### EXAMPLES

### Examples 1-39 and Comparative Examples 1-17

Aminofunctional Silicone Resins A1-A5, A8, A10, and A11 were prepared in the following manner. A mixture of phenyltrimethoxysilane, phenylmethyldimethoxysilane, γ-aminopropyltriethoxysilane (APTES), and/or γ-aminopropyldiethoxymethylsilane (APDEMS) was optionally dissolved in aromatic solvent and hydrolyzed with deionized water, followed by distillative removal of by-product alcohol. The resulting structure was optionally reacted with trimethylethoxysilane, hexamethyldisilazane (HMDZ), APDEMS and/or dimethyldimethoxysilane, additional solvent and additional water added, a catalytic amount of aqueous potassium hydroxide optionally added and the water removed via azeotrope. The hydroxide, if added, was neutralized with aqueous HCl or acetic acid, and water removed again via azeotrope. The mixture was filtered and solvent removed to yield siloxane resin product. The amount of each ingredient is shown in Table 1 below. The final aminofunctional silicone resin composition, wt % phenyl (Ph), wt % R₂SiO (D), wt % Me₂SiO (D(Me₂)), mole percent amino (—CH₂CH₂CH₂NH₂), wt % amine (—NH₂), and —NH— (Amine H) equivalent weight are shown in Table 2 below.

Aminofunctional silicone resins B2-B4 and B7 were prepared in the following manner: Phenyltrimethoxysilane and/or phenylmethyldimethoxysilane, catalyzed by trifluoromethanesulfonic acid (TFMSA), were hydrolyzed with deionized water, followed by distillative removal of by-product alcohol. Hexamethyldisiloxane (HMDS) and additional water were added and the mixture heated to 50-60° C. optionally followed by distillative removal of volatiles. γ-Aminopropyltriethoxysilane (APTES) or γ-aminopropyldiethoxymethylsilane (APDEMS) were added along with additional water, followed by distillative removal of alcohol. Toluene, additional water and optionally a catalytic amount of 1.0 N aqueous potassium hydroxide were added and water removed via azeotrope. If added the hydroxide was neutralized with 1.0 N aqueous HCl, and water again removed via azeotrope. The mixture was filtered and solvent removed. The amount of each ingredient is shown in Table 1 below. The final aminofunctional silicone resin composition, wt % phenyl (Ph), wt % R₂SiO (D), wt % Me₂SiO (D(Me₂)), mole percent amino (—CH₂CH₂CH₂NH₂), wt % amine (—NH₂), and —NH— (Amine H) equivalent weight are shown in Table 2 below.

Aminofunctional Silicone Resin C1 was prepared in the following manner. A mixture (amounts in Table 1) of phenyltrimethoxysilane, phenylmethyldimethoxysilane, and γ-aminopropyldiethoxymethylsilane (APDEMS) was optionally dissolved in xylenes and hydrolyzed with deionized water, followed by distillative removal of by-product alcohol. The resulting structure was reacted with trimethylethoxysilane, additional xylenes and additional water, followed by azeotropic removal of water. To 177.0 grams (g) of this reaction mixture, 19.3 (g) of additional xylenes and 48.5 (g) of colloidal silica dispersion (Ludox® HS-40-220 m²/(g) Grace Davison (Columbia, Md.)) were added and the water removed via azeotrope. The mixture was filtered and solvent removed to yield 110.6 (g) of siloxane resin product. The amount of each ingredient is shown in Table 1 below. The final aminofunctional silicone resin composition, wt % phenyl (Ph), wt % R₂SiO (D), wt % Me₂SiO (D(Me₂)), mole percent amino (—CH₂CH₂CH₂NH₂), wt % amine (—NH₂), and —NH— (Amine H) equivalent weight are shown in Table 2 below.

Aminofunctional Siloxane Resin Dl was prepared in the following manner: 1,1,2,4-Tetramethyl-1-sila-2-azacyclopentane (777.8 g) was added to a solution of Dow Corning® 217 Flake Resin 1000.3 g) dissolved in toluene (428.9 g), filtered and solvent removed to yield 1279.1 g of a viscous liquid.

Aminofunctional Siloxane Resin E1 was prepared in the following manner: A mixture of 119.6 g phenyltrimethoxysilane and 218.8 g phenylmethyldimethoxysilane were hydrolyzed with 67.3 g dilute aqueous HCl (0.02 N), followed by distillative removal of by-product methanol. The hydrolyzate was dissolved in 119.0 g toluene followed by azeotropic removal of residual water and subsequently reacted with 34.4 g cyclosilazane (1,1,2,4-Tetramethyl-1-sila-2-azacyclopentane). 5.1 g dilute aqueous KOH (1.0 N) was added and the mixture heated to reflux for three hours. The mixture was neutralized with 5.2 g aqueous HCl (1.0 N) dried via azeotropic distillation, filtered and solvent removed to yield 265.1 g of the silicone resin E1.

TABLE 1

| | Weight (g) | | | | | | | |
|---|---|---|---|---|---|---|---|---|
| | PhSi(OMe)₃ | PhMeSi(OMe)₂ | Me₂Si(OMe)₂ | APDEMS | Me₃SiOEt | HMDS | Xylene | Toluene |
| Ex. | | | | | | | | |
| A1 | 218.2 | 54.7 | | 76.6 | 35.5 | | 170.0 | |
| A2 | 277.7 | 255.6 | | 153.2 | 71.0 | | 343.8 | |
| A3 | 79.3 | 218.7 | | 76.7 | | | 175.1 | |
| A4 | 158.7 | 145.9 | | 76.6 | | | 173.0 | |
| A5 | 99.2 | 237.0 | | 38.3 | | | 178.0 | |
| A8 | 138.8 | 91.4 | | 153.5 | | | 168.8 | |
| B2 | 205.3 | | | 88.0 | | 78.4 | | 117.6 |
| B3 | 208.2 | 76.7 | | 40.2 | | 35.8 | | 168.9 |
| B4 | 218.1 | 40.1 | | 42.1 | | 56.3 | | 169.4 |
| C1 | 277.7 | 255.6 | | 153.1 | 71.0 | | 343.0 | |
| Comparison | | | | | | | | |
| Examples | | | | | | | | |
| B7 | 161.7 | | 195.9 | 57.4 | | 48.8 | | 189.5 |
| A10 | 312.3 | | 189.5 | 67.0 | | | | 240.9 |
| A11 | | | | 401.8 | | | 221.4 | |

| | Weight (g) | | | | | |
|---|---|---|---|---|---|---|
| | Water | TFMSA | 1.0 N KOH | 45% KOH | 1.0 N HCl | Yield (g) |
| Ex. | | | | | | |
| A1 | 90.1 | | | 4.8 | 4.9 | 237.0 |
| A2 | 165.8 | | 9.6 | | 9.8 | 486.6 |
| A3 | 79.3 | | 4.9 | | 5.0 | 255.8 |
| A4 | 86.5 | | 4.9 | | 5.0 | 250.5 |
| A5 | 81.1 | | 5.0 | | 5.0 | 258.8 |
| A8 | 84.8 | | 4.7 | | 4.8 | 240.4 |
| B2 | 72.5 | 0.14 | | | | 242.4 |
| B3 | 79.6 | 0.13 | 4.7 | | 4.6 | 246.5 |
| B4 | 75.3 | 0.13 | 4.9 | | 4.8 | 245.7 |
| C1 | 165.8 | | | | | |
| Comparison | | | | | | |
| Examples | | | | | | |
| B7 | 103.3 | 0.18 | | 0.8 | | 278.1 |
| A10 | 180.6 | | 6.7 | | 6.6 | 361.3 |
| A11 | 94.8 | | 4.6 | | 4.8 | 239.9 |

TABLE 2

| | | | wt % | wt % | Mol % | wt % | —NH— |
|---|---|---|---|---|---|---|---|
| | Composition | Wt % Ph# | D* | D(Me2) | Amino | Amine* | eq wt |
| Example | | | | | | | |
| A1 | M_{0.079}D^{Ph}_{0.154}D^{NH2}_{0.203}T^{Ph}_{0.564} | 72.8 | 36.1 | 0.0 | 20 | 2.6 | 306 |
| A2 | M_{0.095}D^{Ph}_{0.339}D^{NH2}_{0.206}T^{Ph}_{0.361} | 69.4 | 56.4 | 0.0 | 21 | 2.6 | 302 |
| A3 | D^{Ph}_{0.592}D^{NH2}_{0.205}T^{Ph}_{0.201} | 71.9 | 80.1 | 0.0 | 20 | 2.5 | 320 |
| A4 | D^{Ph}_{0.388}D^{NH2}_{0.206}T^{Ph}_{0.406} | 74.6 | 59.5 | 0.0 | 21 | 2.6 | 314 |
| A5 | D^{Ph}_{0.628}D^{NH2}_{0.102}T^{Ph}_{0.267} | 80.3 | 73.9 | 0.0 | 10 | 1.2 | 645 |
| A8 | D^{Ph}_{0.250}D^{NH2}_{0.395}T^{Ph}_{0.352} | 58.7 | 63.8 | 0.0 | 40 | 5.0 | 160 |
| B2 | M_{0.355}D^{NH2}_{0.198}T^{Ph}_{0.441} | 52.7 | 21.3 | 0.0 | 20 | 2.9 | 279 |
| B3 | M_{0.202}D^{Ph}_{0.199}D^{NH2}_{0.098}T^{Ph}_{0.496} | 73.6 | 30.1 | 0.0 | 10 | 1.4 | 613 |
| B4 | M_{0.299}D^{Ph}_{0.101}D^{NH2}_{0.099}T^{Ph}_{0.497} | 67.5 | 22.3 | 0.0 | 10 | 1.4 | 581 |
| C1 | M_{0.076}D^{Ph}_{0.341}D^{NH2}_{0.189}T^{Ph}_{0.332}Q_{0.059} | 69.9 | 56.6 | 0.0 | 19 | 2.5 | 323 |
| E1 | M^{NH}_{0.115}D^{Ph}_{0.589}T^{Ph}0.293 | 84.7 | 27.8 | 0.0 | 11 | 0.7 | 1186 |
| Comparison | | | | | | | |
| Examples | | | | | | | |
| B7 | M_{0.156}D_{0.481}D^{NH2}_{0.096}T^{Ph}_{0.265} | 41.8 | 50.0 | 38.0 | 10 | 1.6 | 493 |
| A10 | D_{0.415}D^{NH2}_{0.102}T^{Ph}_{0.475} | 64.8 | 41.0 | 29.6 | 10 | 1.6 | 519 |
| A11 | D^{NH2}_{1.00} | 0 | 100 | 0.0 | 100 | 12.0 | 59 |
| D1 | M^{NH}_{0.23}T^{Ph}_{0.77} | 69.0 | 0.0 | 0.0 | 23.0 | 2.6 | 580 |

In Table 2 above:
#molar mass of phenyl in the composition divided by the molar mass of all resin R groups in the composition
*based on the molar mass of the designated group divided by the molar mass of the composition
M denotes (CH₃)₃SiO_{1/2}
M^{NH} denotes (CH₃)₂RSiO_{1/2} where R = —CH₂(CH₃)CHCH₂NHCH₃
D denotes (CH₃)₂SiO_{2/2}
D^{Ph} denotes C₆H₅(CH₃)SiO_{2/2}
D^{NH2} denotes(CH₃)RSiO_{2/2} where R = —CH₂CH₂CH₂NH₂
T^{Ph} denotes C₆H₅SiO_{3/2}
T^{NH2} denotes RSiO_{3/2} where R = —CH₂CH₂CH₂NH₂
Q denotes SiO_{4/2}

Testing Methods/Measures:
T BENDS FLEX TEST: (ASTM D4145) Secure about ½ to ¾ of an inch of a coated panel in a vice. Bend the free end 90 degrees with the coating on the outside of the bend. Continue to bend the panel until it can be clamped in the vise. Tighten the vise to complete the 180° bend. Take care to tighten the vise sufficiently so that the apex of the bend is as flat as can be reasonably achieved. This is called a 0T bend. Examine the bend for cracking. Continue folding the panel over on itself until no cracking occurs (each successive bend produces a less severe strain at the bend). The bend that results in no cracks is reported (lower the number, the better the flex performance).
60° GLOSS: (ASTM D523-89) Measured gloss ratings are obtained by comparing the specular reflectance from the sample to that from a black glass standard. Sixty-degree gloss is used for comparing most samples. Testing is performed using a Gloss-meter (BYK-Gardner Micro-Tri-gloss, Catalog #4522). A minimum of five readings is taken on the coating surface and the average is reported.
RECOATABILITY: The conditions (Application method, film thickness and cure schedule) for this test are specified relative to the specific coating formulation. After the initial cure, the specimen is overcoated with both the same paint formulation and the control topcoat. After curing the topcoat, the panels are rated in regards to the ability of the topcoat to wet the underlying film:

5=Excellent wetting and flow; no film defects such as craters and fisheyes

4=Slight dewetting and/or edge crawling; minimal defects

3=Moderate dewetting and/or edge crawling; minimal defects

2=Extensive dewetting and/or edge crawling; Few defects

1=Extensive dewetting and/or edge crawling; Numerous defects

0=Severe dewetting and/or edge crawling; Extensive defects

### Formulations

Versaine® C-30 is a cycloaliphatic amine curing agent sold by Cognis (Cincinnati, Ohio)

Dytek® EP is an aliphatic amine curing agent sold by DuPont, (Wilmington, Del.)

DER® 331 is a diglycidyl ether of bisphenol A epoxy resin sold by The Dow Chemical Company (Midland Mich.)

Ti-Pure® R-960 is Titanium Dioxide sold by DuPont (Wilmington, Del.)

BY16-853C is a dimethylpropylamino-endblocked dimethylsiloxane oligomer from Dow Corning Toray Silicone Company Limited (Chiba, Japan)

Coatings were formulated using a 2:5 pigment Ti-Pure® R-960 to binder ratio DER® 331 ratio and crosslinked using two different organic amine curing agents, Versamine® C-30 and Dytek® EP, with the amine hydrogen to epoxy equivalents formulated at 1:1 for all. The aminofunctional silicone resins were added at three different levels (approximately 15, 10 and 5 weight percent) with the organic amine curing agents providing the balance of the amine content.

The samples were mixed for thirty minutes on a mixing wheel and then allowed a twenty-minute gestation period before application. Six mil drawdowns were made onto Chromated aluminum panels (AL-39 from Q-Panel Inc. Cleveland, Ohio) and allowed to ambient cure for fourteen days prior to evaluation. Testing included sixty-degree gloss, T-bend flexibility and recoatability. The recoatability of the panels was evaluated by overcoating each sample with an identically silicone modified paint sample as well as an unmodified control sample. Adjustments to the pigment to binder ratio were made using a high pigment content pigment resin doping mixture in combination with the epoxy resin component.

TABLE 3
(in (g))

| | |
|---|---|
| Epoxy Resin Component A: | |
| DER ® 331 | 500 (g) |
| DuPont R960 TiO2 | 200 (g) |
| Methyl Ethyl Ketone | 50 (g) |
| Xylenes | 50 (g) |
| Pigment Dope: | |
| DER ® 331 | 200 (g) |
| DuPont R960 TiO2 | 200 (g) |
| Methyl Ethyl Ketone | 20 (g) |
| Xylenes | 20 (g) |

| | Examples 1-10 Coating Formulations | | | | | | | | | |
|---|---|---|---|---|---|---|---|---|---|---|
| Components | Ex 1 | Ex 2 | Ex 3 | Ex 4 | Ex 5 | Ex 6 | Ex 7 | Ex 8 | Ex 9 | Ex 10 |
| Epoxy Resin | 67.5 | 51.4 | 59.9 | 62.6 | 57.6 | 60.6 | 62.4 | 51.7 | 60.2 | 62.7 |
| Component A | | | | | | | | | | |
| Pigment Dope | 5.1 | 18.1 | 9.9 | 9.5 | 12.7 | 11.2 | 10.3 | 18.2 | 10.0 | 9.5 |
| Versamine ® C-30 | 27.4 | 21.2 | 21.2 | 24.1 | 15.4 | 19.3 | 22.6 | 15.8 | 21.3 | 24.1 |
| A3 (75% solids) | | 14.9 | 9.0 | 3.8 | | | | | | |
| A4 | | | | | 14.3 | 9.0 | 4.7 | | | |
| (75.6% solids) | | | | | | | | | | |
| A2 | | | | | | | | 14.3 | 8.6 | 3.6 |
| (74.4% solids) | | | | | | | | | | |
| Total | 100 | 100 | 100 | 100 | 100 | 100 | 100 | 100 | 100 | 100 |
| Wt % Silicone | 0 | 11.9 | 7.4 | 3.2 | 11.9 | 7.6 | 3.9 | 11.7 | 7.1 | 3.0 |
| Resin | | | | | | | | | | |

TABLE 4
(in (g))
Examples 11-16 and Comparison Examples 1-6 Coating Formulations

| Components | Ex 11 | Ex 12 | Ex 13 | Ex 14 | Ex 15 | Ex 16 | CEx 1 | CEx 2 | CEx 3 | CEx 4 | CEx 5 | CEx 6 |
|---|---|---|---|---|---|---|---|---|---|---|---|---|
| Epoxy Resin | 51.8 | 60.2 | 62.7 | 50.1 | 61.0 | 62.6 | 43.5 | 45.4 | 46.9 | 68.1 | 57.3 | 51.8 |
| Component A | | | | | | | | | | | | |
| Pigment Dope | 18.2 | 10.0 | 9.5 | 20.4 | 10.1 | 9.5 | 37.1 | 35.6 | 34.7 | 18.1 | 26.4 | 31.1 |
| Versamine ® C-30 | 15.8 | 21.3 | 24.1 | 15.1 | 21.6 | 24.0 | 12.3 | 14.5 | 16.1 | 0.0 | 10.7 | 15.1 |
| A1 (76% solids) | 14.2 | 8.5 | 3.6 | | | | | | | | | |
| A5 (75.2% solids) | | | | 14.4 | 7.3 | 3.8 | | | | | | |
| BY16-853C | | | | | | | 7.1 | 4.5 | 2.3 | | | |
| (100% solids) | | | | | | | | | | | | |
| A11 | | | | | | | | | | 13.8 | 5.6 | 2.0 |
| (100% solids) | | | | | | | | | | | | |
| Total | 100 | 100 | 100 | 100 | 100 | 100 | 100 | 100 | 100 | 100 | 100 | 100 |
| Wt % Silicone | 12.2 | 7.3 | 3.1 | 12.3 | 6.2 | 3.3 | 8.2 | 5.1 | 2.6 | 15.4 | 6.4 | 2.3 |
| Resin | | | | | | | | | | | | |

TABLE 5
(in (g))
Examples 17-26 Coating Formulations

| Components | Ex 17 | Ex 18 | Ex 19 | Ex 20 | Ex 21 | Ex 22 | Ex 23 | Ex 24 | Ex 25 | Ex 26 |
|---|---|---|---|---|---|---|---|---|---|---|
| Epoxy Resin | 83.1 | 49.6 | 63.8 | 74.5 | 57.3 | 65.4 | 73.4 | 50.5 | 64.4 | 75.1 |
| Component A | | | | | | | | | | |
| Pigment Dope | 8.2 | 33.1 | 21.3 | 13.7 | 25.7 | 20.1 | 14.5 | 32.3 | 20.9 | 13.2 |
| Dytek ® EP | 8.7 | 3.7 | 5.7 | 7.3 | 3.7 | 5.2 | 6.7 | 3.8 | 5.7 | 7.4 |
| A3 | | 13.7 | 9.3 | 4.5 | | | | | | |
| (75% solids) | | | | | | | | | | |
| A4 | | | | | 13.3 | 9.4 | 5.4 | | | |
| (75.6% solids) | | | | | | | | | | |
| A2 | | | | | | | | 13.3 | 8.9 | 4.3 |
| (74.4% solids) | | | | | | | | | | |
| Total | 100 | 100 | 100 | 100 | 100 | 100 | 100 | 100 | 100 | 100 |
| Wt % Silicone | 0 | 11.8 | 7.9 | 3.8 | 11.5 | 8.1 | 4.6 | 11.3 | 7.6 | 3.6 |
| Resin | | | | | | | | | | |

TABLE 6
(in (g))
Examples 27-32 and Comparison Examples 7-12 Coating Formulations

| Components | Ex 27 | Ex 28 | Ex 29 | Ex 30 | Ex 31 | Ex 32 | CEx 7 | CEx 8 | CEx 9 | CEx 10 | CEx 11 | CEx 12 |
|---|---|---|---|---|---|---|---|---|---|---|---|---|
| Epoxy Comp A | 51.3 | 64.8 | 75.1 | 48.5 | 66.8 | 74.1 | 62.3 | 69.4 | 76.0 | 68.1 | 75.1 | 80.1 |
| Pigment Dope | 31.4 | 20.5 | 13.3 | 34.4 | 19.4 | 14.1 | 21.9 | 16.8 | 12.4 | 18.1 | 13.3 | 9.9 |
| Dytek ® EP | 3.9 | 5.8 | 7.4 | 3.6 | 6.0 | 7.3 | 4.9 | 6.3 | 7.5 | 0.0 | 3.8 | 6.6 |
| A1(76% solids) | 13.4 | 8.9 | 4.3 | | | | | | | | | |
| A5(75.2% solids) | | | | 13.4 | 7.9 | 4.5 | | | | | | |
| BY16-853C | | | | | | | 10.9 | 7.5 | 4.2 | | | |
| A11 (100% solids) | | | | | | | | | | 13.8 | 7.8 | 3.4 |
| Total | 100 | 100 | 100 | 100 | 100 | 100 | 100 | 100 | 100 | 100 | 100 | 100 |
| Wt % Si Resin | 11.6. | 7.7 | 3.8 | 11.6 | 6.8 | 3.9 | 12.5 | 8.6 | 4.8 | 15.9 | 9.0 | 3.9 |

TABLE 7
Performance Properties of Examples 1-32 and Comparison Examples 1-12

| | | | | | | | Flex 1-10 | Recoat 1-5 | Gloss |
|---|---|---|---|---|---|---|---|---|---|
| | | Flex 1-10 | Recoat 1-5 | Gloss | | | (Low = | (High = | (High = |
| Example # | % Si | (Low = better) | (High = better) | (High = better) | Example | % Si | better) | better) | better) |
| Ex 1(Control) | 0 | 6 | 3 | 100 | Ex 17(Control) | 0 | 8 | 3 | 30 |
| Ex 2 | 11.9 | 3 | 3 | 101 | Ex 18 | 11.8 | 3 | 3 | 70 |
| Ex 3 | 7.4 | 4 | 3 | 101 | Ex 19 | 7.9 | 2 | 3 | 60 |
| Ex 4 | 3.2 | 3 | 4 | 100 | Ex 20 | 3.8 | 7 | 3 | 50 |
| Ex 5 | 11.9 | 4 | 3 | 101 | Ex 21 | 11.5 | 4 | 3 | 50 |
| Ex 6 | 7.6 | 7 | 3 | 102 | Ex 22 | 8.1 | 4 | 3 | 40 |
| Ex 7 | 3.9 | 5 | 3 | 101 | Ex 23 | 4.6 | 3 | 3 | 35 |
| Ex 8 | 11.7 | 3 | 1 | 101 | Ex 24 | 11.3 | 2 | 3 | 68 |
| Ex 9 | 7.1 | 5 | 1 | 100 | Ex 25 | 7.6 | 3 | 3 | 53 |
| Ex 10 | 3.0 | 4 | 3 | 102 | Ex 26 | 3.6 | 7 | 3 | 40 |
| Ex 11 | 12.2 | 7 | 4 | 102 | Ex 27 | 11.6 | 3 | 3 | 30 |
| Ex 12 | 7.3 | 7 | 4 | 102 | Ex 28 | 7.7 | 3 | 3 | 25 |
| Ex 13 | 3.1 | 5 | 4 | 102 | Ex 29 | 3.8 | 4 | 3 | 20 |
| Ex 14 | 12.3 | 2 | 1 | 101 | Ex 30 | 11.6 | 2 | 3 | 70 |
| Ex 15 | 6.2 | 3 | 1 | 101 | Ex 31 | 6.8 | 2 | 3 | 83 |
| Ex 16 | 3.3 | 3 | 3 | 100 | Ex 32 | 3.8 | 4 | 3 | 85 |
| CEx 1 | 8.2 | 4 | 0 | 76 | CEx 7 | 12.5 | * | 3 | * |
| CEx 2 | 5.1 | 4 | 0 | 81 | CEx 8 | 8.6 | * | 3 | * |
| CEx 3 | 2.6 | 4 | 0 | 95 | CEx 9 | 4.8 | * | 3 | * |
| CEx 4 | 15.4 | NA | 5 | 80 | CEx 10 | 15.9 | NA | 4 | 45 |
| CEx 5 | 6.4 | NA | 4 | 82 | CEx 11 | 9.0 | NA | 4 | 35 |
| CEx 6 | 2.3 | NA | 5 | 102 | CEx 12 | 3.9 | NA | 4 | 20 |

* not tested due to poor film quality

The coating compositions of this invention provide enhanced flexibility (compared to controls) to the epoxy coatings with some enhancement in gloss without creating recoating issues in most cases. Also, the coating compositions of the invention provide enhanced performance relative to the linear siloxanes and linear aminosiloxane polymers (gloss) that are provided as comparisons. However, it is clear that there is not one coating composition in these examples that provides the best performance for both systems and for all properties. Hence, a range of coating formulations need to be considered for optimizing a range of properties in a range of epoxy coating systems.

### Comparison Examples 13-15

Aminofunctional silicone resin modified epoxy-based paints were prepared so that the aminofunctional silicone resin provided 10 mole % of the amine hydrogens (—NH—) resulting in 12-14 wt % loading of aminofunctional silicone resin in the formulation as shown in Table 8. After mixing for 30 minutes the formulations were allowed to stand for an additional 15 minutes and then applied to steel and aluminum panels at 6 mils wet film thickness. Prior to testing, the panels were allowed to cure at ambient conditions for seven days. Compared to the control Comparison Example 13 exhibited enhanced flexibility but an unfavorable loss of gloss and recoatability. Comparison Example 14 displayed poor recoatability and gloss with similar flexibility as the control. Comparison Example 15 exhibited recoatability similar to the control but no enhancement in flexibility.

TABLE 8

Weight (g)

| Material | Control | CEx 13 | CEx 14 | CEx 15 |
|---|---|---|---|---|
| DER ® 331 | 46.9 | 46.9 | 46.9 | 46.9 |
| Ti-Pure ® R-960 | 18.8 | 18.8 | 18.8 | 18.8 |
| MEK | 4.6 | 4.6 | 4.6 | 4.6 |
| Xylene | 4.6 | 4.6 | 4.6 | 4.6 |
| Versamine ® C-30 | 25.1 | 22.6 | 22.6 | 22.6 |
| B7 | | 12.2 | | |
| A10 | | | 12.8 | |
| D1 | | | | 14.3 |
| Amine H:epoxy | 1:1 | 1:1 | 1:1 | 1:1 |

### Examples 33 and 34

### Comparative Examples 16 and 17

Materials

Jeffamine® D-230 is an aliphatic amine curing agent from Huntsman (Salt Lake City Utah).

Test Methods:

Thermogravimetric Analysis

Thermogravimetric analysis was performed using a TA Instruments (New Castle, Del.) TGA 2950. Approximately 7 to 12 mg of a single piece of the test specimen was placed in a Pt pan and heated to 1000° C. at 10° C./min under an air atmosphere and the weight loss continuously monitored and recorded. The weight loss at 400° C. was reported. The uncertainty was estimated to be ±5% based on duplicate analysis.

Dynamic Mechanical Thermal Analysis

Dynamic mechanical thermal analysis was conducted using a Rheometric Scientific (TA Instruments, New Castle, Del.) RDAII equipped with rectangular torsion fixtures. Rectangular test specimens were cut such that thickness ranged from 1.4 to 1.6 mm, the width was between 6 and 7 mm, and the free length was from 24 to 28 mm. A dynamic frequency of 1 Hz and a heating rate of 2° C./min were applied. A strain sweep was conducted at the starting temperature (−102° C.) to determine an appropriate strain to measure the linear viscoelastic properties; the dynamic strain ranged from 0.012 to 0.040%. The autostrain (5% increments) and autotension options were used. The tool expansion was based on 2.12 μm/° C. The shear storage modulus at 25° C. was reported.

Water Absorption

The water uptake over time was measured using a Mettler-(Toledo, Ohio) AE163 balance that read to 10 μg. Test specimens were first conditioned in a dessicator for over a week before being submerged in water at ambient conditions. Prior to weighing, all six sides of the test specimen were blotted dry using filter paper. The weight of the samples were measured periodically over 1000 hours of water submersion and the 1000-hour value reported.

### Example 33

2 (g) of aminofunctional silicone resin B3 identified above was syringed into a small circular aluminum mold. 0.61 (g) of DER® 331 was added using a 5 ml syringe and the materials were mixed well at room temperature using a wooden stir rod. The translucent mixture was cured in a nitrogen purged laboratory oven for 1 hour at 100° C. followed by 1 hour at 150° C. and then slowly cooled to 30° C. A solid, colorless, transparent disk with good adhesion to the aluminum mold resulted. The thin aluminum mold was peeled from the sample and the material was machined to provide a rectangular sample for evaluation by dynamic mechanical thermal analysis (DMTA), water absorption and thermal analysis. The results are summarized in Table 9.

### Example 34

2 (g) of aminofunctional silicone resin B4 was syringed into a small circular aluminum mold. 0.67 (g) of DER® 331 was added using a 5 ml syringe and the materials were mixed well at room temperature using a wooden stir rod. The hazy white mixture was cured in a nitrogen purged laboratory oven for 1 hour at 100° C. followed by 1 hour at 150° C. and then slowly cooled to 30° C. A solid, colorless, slightly translucent disk with good adhesion to the aluminum mold resulted. The thin aluminum mold was peeled from the sample and the material was machined to provide a rectangular sample for evaluation by dynamic mechanical thermal analysis (DMTA), water absorption and thermal analysis. The results are summarized in Table 9.

### Comparative Example 16

3 (g) of DER® 331 was syringed into a small circular aluminum mold. 0.41 (g) of Dytek® EP was added using a 5 ml syringe and the materials were mixed well at room temperature using a wooden stir rod. The clear mixture was cured in a nitrogen purged laboratory oven for 1 hour at 100° C. followed by 1 hour at 150° C. and then slowly cooled to 30° C. A solid, colorless, transparent disk with good adhesion to the aluminum mold resulted. The thin aluminum mold was peeled from the sample and the material was machined to provide a rectangular sample for evaluation by dynamic mechanical thermal analysis (DMTA), water absorption and thermal analysis. The results are summarized in Table 9.

### Comparative Example 17

3 (g) of DER® 331 was syringed into a small circular aluminum mold. 0.91 (g) of Jeffamine® D-230 was added using a 5 ml syringe and the materials were mixed well at room temperature using a wooden stir rod. The slightly hazy mixture was cured in a nitrogen purged laboratory oven for 1 hour at 100° C. followed by 1 hour at 150° C. and then slowly cooled to 30° C. A solid, colorless, slightly translucent disk with good adhesion to the aluminum mold resulted. The thin aluminum mold was peeled from the sample and the material was machined to provide a rectangular sample for evaluation by dynamic mechanical thermal analysis (DMTA), water absorption and thermal analysis. The results are summarized in Table 9.

TABLE 9

| | | | | H₂O | | |
|---|---|---|---|---|---|---|
| | G | | | Abs | Wt Loss at | |
| | (25° C.) | | | wt % | 400° C. | |
| | Gpa | GN | T_{g} | 1000 Hr | (air) | Comments |
| Ex 33 | 0.58 | 1.84 | 72.7 | 0.21% | 16% | Transparent |
| | | | | | | colorless |
| Ex 34 | 0.39 | 2.14 | 69.4 | 0.19% | 20% | Slight |
| | | | | | | Haze/rigid |
| CEx 16 | 0.95 | 11.9 | 138.2 | 2.36% | 61% | Transparent, |
| | | | | | | colorless |
| CEx 17 | 1.14 | 8.49 | 91.1 | 2.48% | 67% | Slight haze rigid |
| | | | | | | at RT |

Unlike Examples 1-32 and Comparison Examples 1-12 where the aminofunctional silicone resin provided only part of the amino functionality along with an organic amine hardener, in Examples 33 and 34 the aminofunctional silicone resin provides all of the amino functionality to react with the epoxy functionality of DER® 331 stoichiometrically. Table 9 shows that the aminofunctional silicone resins provide materials with considerably lower stiffness, water absorption and weight loss at 400° C. than the epoxy-organic amine Comparison Examples 16 and 17. Flexibility, with low water absorption and high thermal stability are desirable properties for epoxy-based compositions in electronic adhesive and encapsulating applications.

### Example 35

2 (g) of aminofunctional silicone resin C1 was syringed into a small circular aluminum mold. 1.15 (g) of DER® 331 was added using a 5 ml syringe and the materials were mixed well at room temperature using a wooden stir rod. The translucent mixture was cured in a nitrogen purged laboratory oven for 1 hour at 100° C. followed by 1 hour at 150° C. and then slowly cooled to 30° C. A solid, colorless, slightly translucent disk with good adhesion to the aluminum mold and good scratch resistance resulted. The thin aluminum mold was peeled from the sample and the material was machined to provide a rectangular sample for evaluation by dynamic mechanical thermal analysis (DMTA). The material exhibited a room temperature shear storage modulus of 0.77 GPa and a glass transition temperature of 85° C. The addition of Q colloidal silica into the amino resin composition enables the room temperature modulus to be increased in a controlled manner enhancing the scratch resistance of the material.

Materials:

Epoxyfunctional Silicone Resin E1

4752 (g) of phenyltrimethoxysilane was catalyzed by 2.1 (g) of trifluoromethanesulfonic acid, which was then hydrolyzed with 501.0 (g) of deionized water, followed by distillative removal of by-product methanol. 1316.1 (g) of 1,1,3,3-tetramethyl-1,3-disiloxane and 588.6 (g) of acetic acid were added and the mixture heated to 50° C. for three hours. Methanol and methyl acetate were removed via distillation. 1299.8 (g) of Heptane was added and the mixture washed with saturated aqueous sodium bicarbonate and multiple aliquots of deionized water, filtered and solvent removed to yield 4051.6 grams of clear, colorless liquid hydrogen-functional silicone resin intermediate. 250.40 (g) of the silicone resin intermediate was dissolved in 249.97 (g) of toluene and heated to 90° C. 1% Pt(Al₂O₃) was added, followed by slow addition of 119.7 (g) of allyl glycidyl ether such that the reaction temperature did not exceed 90° C. After several hours, another 40.0 grams of allyl glycidyl ether and 0.625 grams of 1% Pt(Al₂O₃) was added. After completion of the reaction, the mixture was filtered and solvent removed. The resulting products was an epoxyfunctional silicone resin (E1) comprising the units: (R(CH₃)₂SiO_{1/2})_{0.39} and ((C₆H₅)SiO_{3/2})_{0.59} where R is 3-glycidoxypropyl.

### Example 36

1.2 (g) of aminofunctional silicone resin A8 was syringed into a small circular aluminum mold. 0.7 (g) of epoxyfunctional silicone resin E1 and 1.16 (g) of DER® 331 were added using 5 ml syringes and the materials were mixed well at room temperature using a wooden stir rod. The slightly hazy mixture was cured in a nitrogen purged laboratory oven for 2 hours at 150° C. and then slowly cooled to 30° C. A solid, colorless, slightly translucent disk with good adhesion to the aluminum mold resulted.

Example 36 shows how an epoxyfunctional silicone resins can be utilized to provide some of the epoxy functionality in order to increase the total silicone content of the hybrid material and still maintain amine H (—NH—) to epoxy ring stoichiometry.

Materials:

ERL® 4221D is a cycloaliphatic epoxy resin sold by The Dow Chemical Company (Midland, Mich.)

### Example 37

3.0 (g) of aminofunctional silicone resin B2 was syringed into a small circular aluminum mold. 1.41 (g) of ERL® 4221D was added using 5 ml syringes and was mixed well at room temperature using a wooden stir rod. A 2 ml sample of this liquid formulation was removed from the mold and stored at room temperature. The rest of this translucent formulation was cured in a nitrogen purged laboratory oven for 1 hour at 100° C., 1 hour at 150° C. and 1 hour at 200° C. and then slowly cooled to 30° C. A yellow tinted, transparent, tough solid with moderate adhesion to the aluminum mold resulted. The retained liquid formulation remained liquid for over three months at room temperature indicating the potential for a 1 part stable curable formulation from this system.

### Example 38

Materials: EPI-REZ 3510-W-60 is a diglycidyl ether of bisphenol A epoxy resin emulsion at 60 weight percent solids with an epoxy equivalent weight of 187 (based on solids) from Resolution Performance Products (Houston Tex.)

30.0 g of an aminofunctional silicone resin B4, was weighed into a Hauschild (Hamm, Germany) Max 40 plastic cup followed by 0.9 g of Tergitol® TMN-6 (2,6,8-trimethyl-4-nonyloxypolyethylene oxyethanol (6 EO) a nonionic surfactant from The Dow Chemical Company (Midland, Mich.)), 1.0 g Tergitol® 15-S-30 (alkylene-oxypolyethylene oxyethanol (C₁₁₋₁₅ secondary alkyl, 30 EO) a nonionic surfactant from The Dow Chemical Company (Midland, Mich.) and 2.0 g of deionized water. The cup was closed and placed into a Hauschild (Hamm, Germany) Speedmixer™ DAC-150 laboratory mixing device. The cup and its contents were cycled in the mixer for 20 seconds. The cup was opened and the walls of the cup were scraped with a spatula. The cup and its contents were subjected to a second 20 second mixing cycle. Next 6 g of DI water was added and the cup was again subjected to a 20 second mixing cycle. An additional 10 g of DI water was added in increments of 5 g followed by a 20 second mixing cycle after each addition. The emulsion that resulted was milky white in appearance with a slight bluish tint. The emulsion consisted of an approximately 60% by weight resin oil particle phase. Mean particle size was measured using a Microtrac® (Montgomeryville, Pa.) UPA150 instrument and had the following properties: D(v, 0.5)=0.2766 um, D(v, 0.9)=0.3467 um.

12.44 (g) of this amino functional siloxane resin emulsion was then weighed into a 2 oz glass vial. 4 (g) of EPI-REZ 3510-W-60 was added to the vial and the contents shook vigorously for one minute by hand. The emulsion blend formed a homogeneous and stable white emulsion blend. Approximately 1 (g) of the blend emulsion was applied as a thin film to each of two 2 inch by 3 inch glass slides. One glass slide was placed in a nitrogen purged oven at 80° C. for two hours. The resulting film was rigid, transparent and exhibited strong adhesion to the glass slide. The other glass slide was allowed to cure overnight at room temperature. The resulting film was tack free, tough, transparent and exhibited good adhesion to the glass slide.

### Example 39

1.02 g of amino functional siloxane resin E1 was weighed into a glass vial followed by the addition of 5.68 g of DER® 331 and 3.35 g Versamine® C-30. The ingredients were mixed thoroughly with a wooden stir rod resulting in a clear and colorless mixture containing 10% by weight of siloxane resin E1 and stoichiometric ratio of amine to epoxy. Six mil drawdowns were made onto Chromated aluminum panels (AL-39 from Q-Panel Inc. Cleveland, Ohio) and the panels were exposed to a nitrogen purged oven for one hour at 100° C. and one hour at 150° C. The cured film was clear and colorless and had increased flexibility (4) compared to a control sample (6) with no siloxane resin added as measured by T Bend Flex Test (ASTM D4145).

1. A coating composition comprising:
(A) 100 weight parts of at least one epoxy resin;
(B) 3-300 weight parts of at least one aminofunctional silicone resin comprising the units:
(R₃SiO_{1/2})ₐ (i)
(R₂SiO_{2/2})_{b} (ii)
(RSiO_{3/2})_{c} (iii) and
(SiO_{4/2})_{d} (iv)
wherein R is independently an alkyl group, an aryl group, or an aminofunctional hydrocarbon group, a has a value of less than 0.4, b has a value of greater than 0.15, c has a value of greater than zero to 0.7, d has a value of less than 0.2, the value of a+b+c+d=1, with the provisos that 3 to 50 mole percent of silicon atoms contain aminofunctional hydrocarbon groups in units (i), (ii) or (iii), the —NH— equivalent weight of the aminofunctional silicone resin is from 100 to 1500, the aminofunctional silicone resin is in the form of a neat liquid, solution, or meltable solid, greater than 20 weight percent of unit (ii) is present in the aminofunctional silicone resin, less than 10 weight percent of unit (ii) are Me₂SiO_{2/2} units in the aminofunctional silicone resin, and greater than 50 weight percent of silicon-bonded R groups are silicon-bonded aryl groups;
(C) up to 50 weight parts of at least one organic hardener;
(D) up to 100 weight parts of at least one epoxyfunctional silicone resin comprising the units:
((R³)₃SiO_{1/2})ₑ (i)
((R³)₂SiO_{2/2})_{f} (ii) and
((R³)SiO_{3/2})_{g} (iii)
wherein R³ is independently an alkyl group having from 1 to 8 carbon atoms, an aryl group having from 1 to 8 carbon atoms, a glycidyl ether group, an alkyl epoxy group, or a cycloaliphatic epoxy group, e has a value of 0.1 to 0.5, f has a value of 0.1 to 0.5, and g has a value of 0.5 to 0.9, with the proviso that the epoxyfunctional silicone resin has an epoxy equivalent weight of 200 to 700; and
(E) up to 10 weight parts of at least one cure accelerator.

2. A coating composition comprising:
(A) 100 weight parts of at least one epoxy resin;
(B) 3-300 weight parts of at least one aminofunctional silicone resin comprising the units:
(R₃SiO_{1/2})ₐ (i)
(R₂SiO_{2/2})_{b} (ii)
(RSiO_{3/2})_{c} (iii) and
(SiO_{4/2})_{d} (iv)
wherein R is independently an alkyl group, an aryl group, or an aminofunctional hydrocarbon group, a has a value of less than 0.4, b has a value of greater than 0.15, c has a value of greater than zero to 0.7, d has a value of less than 0.2, the value of a+b+c+d=1, with the provisos that 3 to 50 mole percent of silicon atoms contain aminofunctional hydrocarbon groups in units (i), (ii) or (iii), the —NH— equivalent weight of the aminofunctional silicone resin is from 100 to 1000, the aminofunctional silicone resin is in the form of a neat liquid, solution, or meltable solid, greater than 20 weight percent of unit (ii) is present in the aminofunctional silicone resin, less than 10 weight percent of unit (ii) are Me₂SiO_{2/2} units in the aminofunctional silicone resin, and greater than 50 weight percent of silicon-bonded R groups are silicon-bonded aryl groups;
(C) up to 50 weight parts of at least one organic hardener;
(D) up to 100 weight parts of at least one epoxyfunctional silicone resin comprising the units:
((R³)₃SiO_{1/2})ₑ (i)
((R³)₂SiO_{2/2})_{f} (ii) and
((R³)SiO_{3/2})_{g} (iii)
wherein R³ is independently an alkyl group having from 1 to 8 carbon atoms, an aryl group having from 1 to 8 carbon atoms, a glycidyl ether group, an alkyl epoxy group, or a cycloaliphatic epoxy group, e has a value of 0.1 to 0.5, f has a value of 0.1 to 0.5, and g has a value of 0.5 to 0.9, with the proviso that the epoxyfunctional silicone resin has an epoxy equivalent weight of 200 to 700; and
(E) up to 10 weight parts of at least one cure accelerator.

3. A composition according to claim 1 wherein component (A) is selected from diglycidyl ether resin, novolak epoxy resin, o-cresol novolak epoxy resins, phenol novolak epoxy resins, cycloaliphatic epoxy resins, glycidyl ethers of polyvalent phenols, glycidyl ethers of resorcinol, glycidyl ethers of hydroquinone, glycidyl ethers of catechol, polygycidyl ethers of phenol novolak epoxy resins alicyclic epoxy resins derived from the epoxidation of an olefin bond, the product of the reaction of 2,2-bis-(hydroxy-phenyl)-propane (bisphenol A) and epichlorohydrin, triglycidyl isocyanurate, or products obtained from the reaction of bis-(4-hydroxy-phenyl)-methane (bisphenol F) and epichlorohydrin.

4. A composition according to claim 1 wherein R is independently selected from methyl, phenyl, or an aminofunctional hydrocarbon group having the formula —R¹NHR² or —R¹NHR¹NHR² wherein each R¹ is independently a divalent hydrocarbon radical having at least 2 carbon atoms and R² is hydrogen or an alkyl group.

5. A composition according to claim 1 Component (B) is selected from
aminofunctional silicone resins comprising the units:
(i) ((CH₃)₃SiO_{1/2})ₐ
(ii) (C₆H₅(CH₃)SiO_{2/2})_{b}
(iii) ((CH₃)RSiO_{2/2})_{b} where R═—CH₂CH₂CH₂NH₂
(iv) (C₆H₅SiO_{3/2})_{c},
aminofunctional silicone resins comprising the units:
(i) (C₆H₅(CH₃)SiO_{2/2})_{b}
(ii) ((CH₃)RSiO_{2/2})_{b} where R═—CH₂CH₂CH₂NH₂
(iii) (C₆H₅SiO_{3/2})_{c}
aminofunctional silicone resins comprising the units:
(i) ((CH₃)₃ SiO_{1/2})ₐ
(ii) ((CH₃)RSiO_{2/2})_{b} where R═—CH₂CH₂CH₂NH₂
(iii) (RSiO_{3/2})_{c} where R═—CH₂CH₂CH₂NH₂
(iv) (C₆H₅SiO₃₁₂)_{c},
aminofunctional silicone resins comprising the units:
(i) ((CH₃)₃SiO_{1/2})ₐ
(ii) ((CH₃)RSiO_{2/2})_{b} where R═—CH₂CH₂CH₂NH₂
(iii) (C₆H₅SiO_{3/2})_{c}
aminofunctional silicone resin comprising the units
(i) ((CH₃)₃SiO_{1/2})ₐ
(ii) (CH₃)₂SiO_{2/2})_{b}
(iii) ((CH₃)RSiO_{2/2})_{b} where R═—CH₂CH₂CH₂NH₂
(iv) (C₆H₅SiO_{3/2})_{c}
aminofunctional silicone resin comprising the units:
(i) ((CH₃)₂RSiO_{1/2})ₐ where R═—CH₂(CH₃)CHCH₂NHCH₃
(ii) (CH₃)₂SiO₂₁₂)_{b}
(iii) (C₆H₅(CH₃)SiO_{2/2})_{b}
(iv) (C₆H₅SiO_{3/2})_{c}
aminofunctional silicone resins comprising the units:
(i) ((CH₃)₂RSiO_{1/2})ₐ where R═—CH₂(CH₃)CHCH₂NHCH₃
(ii) (C₆H₅(CH₃)SiO_{2/2})_{b}
(iii) (C₆H₅SiO_{3/2})_{c},
aminofunctional silicone resins comprising the units:
(i) ((CH₃)RSiO_{2/2})_{b} where R═—CH₂(CH₃)CHCH₂NHCH₃
(ii) (C₆H₅(CH₃)SiO_{2/2})_{b}
(iii) (C₆H₅SiO_{3/2})_{c},
aminofunctional silicone resins comprising the units:
(i) ((CH₃)₂RSiO_{1/2})ₐ where R═—CH₂(CH₃)CHCH₂NHCH₃
(ii) (C₆H₅(CH₃)SiO_{2/2})_{b}
(iii) (SiO_{4/2})_{d}, or
aminofunctional silicone resins comprising the units:
(i) ((CH₃)₃SiO_{1/2})ₐ
(ii) (C₆H₅(CH₃)SiO_{2/2})_{b}
(iii) ((CH₃)RSiO_{2/2})_{b} where R═—CH₂CH₂CH₂NH₂
(iv) (C₆H₅SiO_{3/2})_{c}
(v) (SiO_{4/2})_{d}
wherein a, b, c, and d are as defined above.

6. (canceled)

7. A composition according to claim 1 wherein a has a value of 0.1 to 0.3, b has a value of 0.2 to 0.4, c has a value of 0.2 to 0.5, d has a value of 0, 10 to 30 mole percent of silicon atoms contain aminofunctional hydrocarbon groups in units (i), (ii) or (iii), the —NH— equivalent weight of the aminofunctional silicone resin is from 150 to 350, 20 to 50 weight percent of unit (ii) is present in the aminofunctional silicone resin, 0 to 5 weight percent of unit (ii) are Me₂SiO_{2/2} units in the aminofunctional silicone resin, and from 50 to 75 weight percent of silicon-bonded R groups are silicon-bonded aryl groups.

8. A composition according to claim 1 wherein Component (C) is selected from multifunctional primary polyamines, multifunctional secondary polyamines, adducts of multifunctional primary polyamines, adducts of multifunctional secondary polyamines, anhydrides, or polyamides.

9. A composition according to claim 1 wherein R³ is independently selected from methyl, phenyl, 2-glycidoxyethyl, 3-glycidoxypropyl, 4-glycidoxybutyl, 2-(3,4-epoxycyclohexyl)ethyl, 2,3-epoxypropyl, 3,4-epoxybutyl, 4,5-epoxypentyl, 3,4-epoxycyclohexylmethyl, 3,4-epoxycyclohexylethyl, 3,4-epoxycyclohexylpropyl, 3,4-epoxycyclohexylbutyl, or alkyl cyclohexene oxide groups.

10. A composition according to claim 1, wherein Component (D) is selected from
epoxyfunctional silicone resins comprising the units:
(R³(CH₃)₂SiO_{1/2})ₑ
(C₆H₅SiO_{3/2})_{g},
epoxyfunctional silicone resins comprising the units:
(R³(CH₃)₂SiO_{1/2})ₑ
((CH₃)₂SiO_{2/2})_{f}
(C₆H₅SiO_{3/2})_{g},
epoxyfunctional silicone resins comprising the units:
((CH₃)₃ SiO_{1/2})ₑ
(R³(CH₃)SiO_{2/2})_{f}
(C₆H₅SiO_{3/2})_{g},
epoxyfunctional silicone resins comprising the units:
(R³(CH₃)SiO_{2/2})_{f}
(C₆H₅SiO_{3/2})_{g},
epoxyfunctional silicone resins comprising the units:
(R³(CH₃)₂SiO_{1/2})ₑ
(CH₃SiO_{3/2})_{g},
epoxyfunctional silicone resins comprising the units:
(R³(CH₃)₂SiO_{1/2})ₑ
((CH₃)₂SiO_{2/2})_{f}
(CH₃SiO_{3/2})_{g},
epoxyfunctional silicone resins comprising the units:
((CH₃)₃SiO_{1/2})ₑ
(R³(CH₃)SiO_{2/2})_{f}
(CH₃SiO_{3/2})_{g},
epoxyfunctional silicone resins comprising the units:
(R³(CH₃)SiO_{2/2})_{f}
(CH₃SiO_{3/2})_{g}, or
epoxyfunctional silicone resins comprising the units:
((CH₃)₂SiO_{2/2})_{f}
(R³SiO_{3/2})_{g},
wherein R³ is a glycidyl ether group, an alkyl epoxy group, or a cycloaliphatic epoxy group, e has a value of 0.1 to 0.5, f has a value of 0.1 to 0.5, and g has a value of 0.5 to 0.9, with the proviso that the epoxyfunctional silicone resin has an epoxy equivalent weight of 200 to 700.

11. A composition according to claim 1 wherein Component (E) is selected from phosphine compounds, phosphonium salts, imidazoles, imidazolium salts, amines, ammonium salts, diazabicyclo compounds, tetraphenylborates, phenol salts, phenol novolak salts, 2-ethylhexanoates of diazabicyclo compounds, alcohols, dicyandiamide, or boron trifluoride.

12. A composition according to claim 1, wherein the —NH— equivalent weight to epoxy ring equivalent weight ratio is from 0.8:1-1.2:1.

13-16. (canceled)

17. A composition according to claim 19 wherein the emulsion is in the form of spray-dried composite particles.

18. A coating composition obtained by a method comprising reacting:
(A) 100 weight parts of at least one epoxy resin;
(B) 3-300 weight parts of at least one aminofunctional silicone resin comprising the units:
(R₃SiO_{1/2})ₐ (i)
(R₂SiO_{2/2})_{b} (ii)
(RSiO_{3/2})_{c} (iii) and
(SiO_{4/2})_{d} (iv)
wherein R is independently an alkyl group, an aryl group, or an aminofunctional hydrocarbon group, a has a value of less than 0.4, b has a value of greater than 0.15, c has a value of greater than zero to 0.7, d has a value of less than 0.2, the value of a+b+c+d=1, with the provisos that 3 to 50 mole percent of silicon atoms contain aminofunctional hydrocarbon groups in units (i), (ii) or (iii), the —NH— equivalent weight of the aminofunctional silicone resin is from 100 to 1500, the aminofunctional silicone resin is in the form of a neat liquid, solution, or meltable solid, greater than 20 weight percent of unit (ii) is present in the aminofunctional silicone resin, less than 10 weight percent of unit (ii) are Me₂SiO_{2/2} units in the aminofunctional silicone resin, and greater than 50 weight percent of silicon-bonded R groups are silicon-bonded aryl groups;
(C) up to 50 weight parts of at least one organic hardener;
(D) up to 100 weight parts of at least one epoxyfunctional silicone resin comprising the units:
((R³)₃SiO_{1/2})ₑ (i)
((R³)₂SiO_{2/2})_{f} (ii) and
((R³)SiO_{3/2})_{g} (iii)
wherein R³ is independently an alkyl group having from 1 to 8 carbon atoms, an aryl group having from 1 to 8 carbon atoms, a glycidyl ether group, an alkyl epoxy group, or a cycloaliphatic epoxy group, e has a value of 0.1 to 0.5, f has a value of 0.1 to 0.5, and g has a value of 0.5 to 0.9, with the proviso that the epoxyfunctional silicone resin has an epoxy equivalent weight of 200 to 700; and
(E) up to 10 weight parts of at least one cure accelerator.

19. A coating composition in the form of an emulsion comprising:
(A) 100 weight parts of at least one epoxy resin;
(B) 3-300 weight parts of at least one aminofunctional silicone resin comprising the units:
(R₃SiO_{1/2})ₐ (i)
(R₂SiO_{2/2})_{b} (ii)
(RSiO_{3/2})_{c} (iii) and
(SiO_{4/2})_{d} (iv)
wherein R is independently an alkyl group, an aryl group, or an aminofunctional hydrocarbon group, a has a value of less than 0.4, b has a value of greater than 0.15, c has a value of greater than zero to 0.7, d has a value of less than 0.2, the value of a+b+c+d=1, with the provisos that 3 to 50 mole percent of silicon atoms contain aminofunctional hydrocarbon groups in units (i), (ii) or (iii), the —NH— equivalent weight of the aminofunctional silicone resin is from 100 to 1500, the aminofunctional silicone resin is in the form of a neat liquid, solution, or meltable solid, greater than 20 weight percent of unit (ii) is present in the aminofunctional silicone resin, less than 10 weight percent of unit (ii) are Me₂SiO_{2/2} units in the aminofunctional silicone resin, and greater than 50 weight percent of silicon-bonded R groups are silicon-bonded aryl groups;
(C) up to 50 weight parts of at least one organic hardener;
(D) up to 100 weight parts of at least one epoxyfunctional silicone resin comprising the units:
((R³)₃SiO_{1/2})ₑ (i)
((R³)₂SiO_{2/2})_{f} (ii) and
((R³)SiO_{3/2})_{g} (iii)
wherein R³ is independently an alkyl group having from 1 to 8 carbon atoms, an aryl group having from 1 to 8 carbon atoms, a glycidyl ether group, an alkyl epoxy group, or a cycloaliphatic epoxy group, e has a value of 0.1 to 0.5, f has a value of 0.1 to 0.5, and g has a value of 0.5 to 0.9, with the proviso that the epoxyfunctional silicone resin has an epoxy equivalent weight of 200 to 700;
(E) up to 10 weight parts of at least one cure accelerator;
(F) 1 to 20 weight parts of a surfactant based on 100 weight parts of ingredients (A) to (E); and
(G) 20 to 80 weight parts of water based on 100 weight parts of ingredients (A) to (E).

20. A coating composition in the form of an emulsion according to claim 19 wherein Component (B) is selected from
aminofunctional silicone resins comprising the units:
(i) ((CH₃)₃SiO_{1/2})ₐ
(ii) (C₆H₅(CH₃)SiO_{2/2})_{b}
(iii) ((CH₃)RSiO_{2/2})_{b} where R═—CH₂CH₂CH₂NH₂
(iv) (C₆H₅SiO_{3/2})_{c},
aminofunctional silicone resins comprising the units:
(i) (C₆H₅(CH₃)SiO_{2/2})_{b}
(ii) ((CH₃)RSiO_{2/2})_{b} where R═—CH₂CH₂CH₂NH₂
(iii) (C₆H₅SiO_{3/2})_{c},
aminofunctional silicone resins comprising the units:
(i) ((CH₃)₃SiO_{1/2})ₐ
(ii) ((CH₃)RSiO_{2/2})_{b} where R═—CH₂CH₂CH₂NH₂
(iii) (RSiO_{3/2})_{c} where R═—CH₂CH₂CH₂NH₂
(iv) (C₆H₅SiO_{3/2})_{c}
aminofunctional silicone resins comprising the units:
(i) ((CH₃)₃SiO_{1/2})ₐ
(ii) ((CH₃)RSiO_{2/2})_{b} where R═—CH₂CH₂CH₂NH₂
(iii) (C₆H₅SiO_{3/2})_{c}
aminofunctional silicone resin comprising the units
(i) ((CH₃)₃SiO_{1/2})ₐ
(ii) (CH₃)₂SiO_{2/2})_{b}
(iii) ((CH₃)RSiO_{2/2})_{b} where R═—CH₂CH₂CH₂NH₂
(iv) (C₆H₅SiO_{3/2})_{c}
aminofunctional silicone resin comprising the units:
(i) ((CH₃)₂RSiO_{1/2})ₐ where R═—CH₂(CH₃)CHCH₂NHCH₃
(ii) (CH₃)₂SiO_{2/2})_{b}
(iii) (C₆H₅(CH₃)SiO_{2/2})_{b}
(iv) (C₆H₅SiO_{3/2})_{c}
aminofunctional silicone resins comprising the units:
(i) ((CH₃)₂RSiO_{1/2})ₐ where R═—CH₂(CH₃)CHCH₂NHCH₃
(ii) (C₆H₅(CH₃)SiO_{2/2})_{b}
(iii) (C₆H₅SiO_{3/2})_{c},
aminofunctional silicone resins comprising the units:
(i) ((CH₃)RSiO_{2/2})_{b} where R═—CH₂(CH₃)CHCH₂NHCH₃
(ii) (C₆H₅(CH₃)SiO_{2/2})_{b}
(iii) (C₆H₅SiO_{3/2})_{c}
aminofunctional silicone resins comprising the units:
(i) ((CH₃)₂RSiO_{1/2})ₐ where R═—CH₂(CH₃)CHCH₂NHCH₃
(ii) (C₆H₅(CH₃)SiO_{2/2})_{b}
(iii) (SiO_{4/2})_{d}, or
aminofunctional silicone resins comprising the units:
(i) ((CH₃)₃SiO_{1/2})ₐ
(ii) (C₆H₅(CH₃)SiO_{2/2})_{b}
(iii) ((CH₃)RSiO_{2/2})_{b} where R═—CH₂CH₂CH₂NH₂
(iv) (C₆H₅SiO_{3/2})_{c}
(v) (SiO_{4/2})_{d}
wherein a, b, c, and d are as defined above.

21. A composition in the form of an emulsion according to claim 19, wherein the —NH— equivalent weight to epoxy ring equivalent weight ratio is from 0.8:1-1.2:1.

22. A composition in the form of an emulsion according to claim 19, wherein components (A) and (B) are each added to the composition in the form of an emulsion.

23. A composition according to claim 2 wherein Component (B) is selected from aminofunctional silicone resins comprising the units:
(i) ((CH₃)₃SiO_{1/2})ₐ
(ii) (C₆H₅(CH₃)SiO_{2/2})_{b}
(iii) ((CH₃)RSiO_{2/2})_{b} where R═—CH₂CH₂CH₂NH₂
(iv) (C₆H₅SiO_{3/2})_{c},
aminofunctional silicone resins comprising the units:
(i) (C₆H₅(CH₃)SiO_{2/2})_{b}
(ii) ((CH₃)RSiO_{2/2})_{b} where R═—CH₂CH₂CH₂NH₂
(iii) (C₆H₅SiO_{3/2})_{c},
aminofunctional silicone resins comprising the units:
(i) ((CH₃)₃SiO_{1/2})ₐ
(ii) ((CH₃)RSiO_{2/2})_{b} where R═—CH₂CH₂CH₂NH₂
(iii) (RSiO_{3/2})_{c} where R═—CH₂CH₂CH₂NH₂
(iv) (C₆H₅SiO_{3/2})_{c}
aminofunctional silicone resins comprising the units:
(i) ((CH₃)₃SiO_{1/2})ₐ
(ii) ((CH₃)RSiO_{2/2})_{b} where R═—CH₂CH₂CH₂NH₂
(iii) (C₆H₅SiO_{3/2})_{c}
aminofunctional silicone resin comprising the units
(i) ((CH₃)₃SiO_{1/2})ₐ
(ii) (CH₃)₂SiO_{2/2})_{b}
(iii) ((CH₃)RSiO_{2/2})_{b} where R═—CH₂CH₂CH₂NH₂
(iv) (C₆H₅SiO_{3/2})_{c}
aminofunctional silicone resin comprising the units:
(i) ((CH₃)₂RSiO_{1/2})ₐ where R═—CH₂(CH₃)CHCH₂NHCH₃
(ii) (CH₃)₂SiO_{2/2})_{b}
(iii) (C₆H₅(CH₃)SiO_{2/2})_{b}
(iv) (C₆H₅SiO_{3/2})_{c}
aminofunctional silicone resins comprising the units:
(i) ((CH₃)₂RSiO_{1/2})ₐ where R═—CH₂(CH₃)CHCH₂NHCH₃
(ii) (C₆H₅(CH₃)SiO_{2/2})_{b}
(iii) (C₆H₅SiO_{3/2})_{c},
aminofunctional silicone resins comprising the units:
(i) ((CH₃)RSiO_{2/2})_{b} where R═—CH₂(CH₃)CHCH₂NHCH₃
(ii) (C₆H₅(CH₃)SiO_{2/2})_{b}
(iii) (C₆H₅SiO_{3/2})_{c},
aminofunctional silicone resins comprising the units:
(i) ((CH₃)₂RSiO_{1/2})ₐ where R═—CH₂(CH₃)CHCH₂NHCH₃
(ii) (C₆H₅(CH₃)SiO_{2/2})_{b}
(iii) (SiO_{4/2})_{d}, or
aminofunctional silicone resins comprising the units:
(i) ((CH₃)₃SiO_{1/2})ₐ
(ii) (C₆H₅(CH₃)SiO_{2/2})_{b}
(iii) ((CH₃)RSiO_{2/2})_{b} where R═—CH₂CH₂CH₂NH₂
(iv) (C₆H₅SiO_{3/2})_{c}
(v) (SiO_{4/2})_{d}
wherein a, b, c, and d are as defined above.

24. A composition according to claim 2, wherein the —NH— equivalent weight to epoxy ring equivalent weight ratio is from 0.8:1-1.2:1.
